(19) United States
(12) Patent Application Publication
(10) Pub. No.: US 2026/0247278 A1
(43) Pub. Date: Aug. 20, 2026

(54) RICH FEEDBACK INFORMATION FOR ENABLING IMPROVED ENERGY SAVINGS

(71) Applicant: Telefonaktiebolaget LM Ericsson (publ), Stockholm (SE)

(72) Inventors: Germán Bassi, Årsta (SE); Philipp Bruhn, Aachen (DE); Henrik Rydén, Stockholm (SE); Luca Lunardi, Genova (IT); Angelo Centonza, Grenada (ES)

(21) Appl. No.: 18/876,751

(22) PCT Filed: Jun. 14, 2023
(86) PCT No.: PCT/EP2023/065910

§ 371 Date: Dec. 19, 2024

Related U.S. Application Data
(60) Provisional application No. 63/354,807, filed on Jun. 23, 2022.

(51) Int. Cl. H04W 52/02; H04W 36/00

(52) U.S. Cl. CPC H04W 52/0206; H04W 36/0009; H04W 36/0058; H04W 36/0061

(57) ABSTRACT

Various embodiments disclosed herein provide for a method performed by a second network node to provide feedback information to a network node of a wireless network, comprising receiving a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state. Responsive to receiving the request, the method can include monitoring the one or more performance metrics of the group of one or more wireless communication devices, to determine performance feedback information and providing the performance feedback information to the network node.

### RELATED APPLICATIONS

This application claims the benefit of provisional patent application Ser. No. 63/354,807, filed Jun. 23, 2022.

### TECHNICAL FIELD

The present disclosure relates to a wireless communication system, and more specifically to a rich feedback system for enabling improved energy savings in the wireless communication system.

### BACKGROUND

As mobile data traffic increases due to the popularization of smartphones and data heavy applications, user traffic demand in the wireless networks increases. One way to improve capacity of networks is to deploy capacity (booster) cells, sometimes with lower output power, which are deployed under an umbrella of cells providing basic coverage and are typically placed in areas with high user traffic demand. By activating the capacity cell at times of high traffic demand around it, some users or Wireless Communication Devices (WCDs) in the cell that provides basic coverage can be offloaded to the capacity cell, which ideally would lead to gains in terms of capacity and energy.

Energy efficiency is an important aspect for mobile radio networks, and one method for network energy saving is to put capacity cells into sleep mode when they are no longer needed to serve the present user traffic demand. The activation of a capacity cell can be triggered by another base station (i.e., gNB), and finding the correct times for doing so is typically a tradeoff between network energy efficiency and network capacity, which may (or may not) affect the Quality of Service (QoS) or Quality of Experience (QoE) of users. The goal is to enable just enough network capacity so that the network can provide satisfactory levels of experience for users while at the same time, saving as much energy as possible.

The user data traffic in a cell is generally not uniform in time (e.g., throughout a day) but may vary substantially. As stated above, whenever the traffic demand reduces around a cell, it can be more energy efficient to turn it off until the demand increases again. For example, a Next-Generation Radio Access Network (NG-RAN) node 1 can decide to shut down one (or more) of its cell(s) and hand over WCDs served by the cell(s) to (an) other cell(s) controlled by a NG-RAN node 2. Afterwards, the first node can get feedback from the second node, or the Operations, Administration and Maintenance (OAM) function can get feedback from the first and/or second node, regarding performance (impact) of the cell shutdown(s) on handed-over WCDs.

Equivalently, another possible action to reduce a cell's energy consumption when traffic demand in a cell coverage area reduces is to reconfigure the cell in a way that the cell's energy consumption decreases, for example: switching off cell carriers, reducing the number of transmission points used for the cell, and others.

The above reasoning also applies to the case of Multi-Radio Dual Connectivity (MR-DC), which provides higher data rates and enhanced coverage. In this case, the cell that is deactivated or reconfigured also encompasses a serving cell of the Secondary Node (SN) in an MR-DC scenario.

### 1 Network Energy Efficiency in Third Generation Partnership Project (3GPP)

### 1.1 NG-RAN Node Configuration Update Procedure

Clause 8.4.2 of TS 38.423 v16.7.0 describes this procedure. The NG-RAN node Configuration Update procedure allows an NG-RAN node to transmit to a neighboring NG-RAN node an update of configuration information that is essential for the two NG-RAN nodes to interoperate correctly over an Xn-C interface.

The NG-RAN node Configuration Update procedure uses non-UE associated signaling.

### Successful Operation

The first NG-RAN node initiates the procedure by sending a NG-RAN NODE CONFIGURATION UPDATE message to a second NG-RAN node.

Upon receipt of this message, the second NG-RAN node should update the configuration data associated to the first NG-RAN node that it has stored locally.

The NG-RAN NODE CONFIGURATION UPDATE message may comprise a list of served NR cells to update, or a list of served Evolved Universal Terrestrial Radio Access (E-UTRA) cells to update, or both, which may comprise a Served Cells NR to Modify Information Element (IE) and Served Cells E-UTRA To Modify IE, respectively.

If the Deactivation Indication IE is comprised in the Served Cells NR to Modify IE, it indicates that the corresponding cell was switched off for Network (NW) energy saving. Analogously, if the Deactivation Indication IE is comprised in the Served Cells E-UTRA To Modify IE, it indicates that the corresponding cell was switched off for NW energy saving.

### Unsuccessful Operation

If the second NG-RAN node cannot accept the update, it should respond with a NG-RAN NODE CONFIGURATION UPDATE FAILURE message and with an appropriate cause value.

For further details, refer to 3GPP TS 38.423.

### 1.2 Cell Activation Procedure

Clause 8.4.3 of TS 38.423 describes this procedure. The Cell Activation procedure enables an NG-RAN node to request a neighboring NG-RAN node to switch on one or more cells, which have been reported as switched off for NW energy saving at an earlier point in time.

The Cell Activation procedure uses non-UE-associated signaling.

### Successful Operation

A first NG-RAN node can initiate the procedure by sending a CELL ACTIVATION REQUEST message to a second NG-RAN node.

Upon receipt of this message, the second NG-RAN node should switch on cell(s) indicated in the CELL

ACTIVATION REQUEST message and afterwards indicate in a CELL ACTIVATION RESPONSE message to the first NG-RAN node for which cell(s) the request was fulfilled.

Interactions with NG-RAN Configuration Update procedure:

If the second NG-RAN node turns on one or more cells upon receipt of a CELL ACTIVATION REQUEST message from the first NG-RAN node, and if the second NG-RAN node afterwards responds to said request via a CELL ACTIVATION RESPONSE message, the second NG-RAN node shall not send a NG-RAN CONFIGURATION UPDATE message to inform the first NG-RAN node about cell activation state change(s).

### Unsuccessful Operation

If the second NG-RAN node cannot turn on any of the cells indicated in the CELL ACTIVATION REQUEST message sent by the first NG-RAN node, it shall respond with a CELL ACTIVATION FAILURE message with an appropriate cause value.

For further details, refer to 3GPP TS 38.423.

### 1.3 Additional 3GPP Background

*****BEGIN Excerpt from 3GPP TS 28.310 V17.3.0*****
   5.1.3.2.2:

For the distributed energy saving, the NR capacity booster cell may decide to enter the energy saving mode when it detects that its traffic load is below certain threshold, and its coverage can be provided by the candidate cells. However, the NR capacity booster cell can be switched off only after the handover actions to off-load its traffic to the candidate cells is completed (see clause 15.4.2 in TS 38.300 [13]). The candidate cell decides to re-activate the NR capacity booster cell when it detects additional capacity is needed (see clause 15.4.2 in TS 38.300 [13]).
*****End Excerpt from 3GPP TS 28.310 V17.3.0*****
*****BEGIN Excerpt from 3GPP TR 37.817 V1.3.0*****
   5.1.2.3:

In this solution, NG-RAN is responsible for model training and generates energy saving decisions.
Step 0: NG-RAN node 2 is assumed to have an AI/ML model optionally, which can provide NG-RAN node 1 with input information.
Step 1: NG-RAN node 1 configures the measurement information on the UE side and sends configuration message to UE to perform measurement procedure and reporting.
Step 2: The UE collects the indicated measurement(s), e.g. UE measurements related to RSRP, RSRQ, SINR of serving cell and neighbouring cells.
Step 3: The UE sends the measurement report(s) to NG-RAN node 1 including the required measurement result.
Step 4: NG-RAN node 2 sends the required input data to NG-RAN node 1 for model training of AI/ML-based network energy saving.
Step 5: NG-RAN node 1 trains AI/ML model for AI/ML-based energy saving based on collected data. NG-RAN node 2 is assumed to have AI/ML model for AI/ML-based energy saving optionally, which can also generate predicted results/actions.
Step 6: NG-RAN node 2 sends the required input data to NG-RAN node 1 for model inference of AI/ML-based network energy saving.
Step 7: UE sends the UE measurement report(s) to NG-RAN node 1.
Step 8: Based on local inputs of NG-RAN node 1 and received inputs from NG-RAN node 2, NG-RAN node 1 generates model inference output (e.g. energy saving strategy, handover strategy, etc).
Step 9: NG-RAN node 1 executes Network energy saving actions according to the model inference output. NG-RAN node 1 may select the most appropriate target cell for each UE before it performs handover, if the output is handover strategy.
Step 10: NG-RAN node 2 provides feedback to NG-RAN node 1.
   *****End Excerpt from 3GPP TR 37.817 V1.3.0

Furthermore, with respect to feedback, clause 5.1.2.6 states:
*****BEGIN Excerpt from 3GPP TR 37.817 V1.3.0*****
   5.1.2.6:

To optimize the performance of AI/ML-based network energy saving model, following feedback can be considered to be collected from NG-RAN nodes:
Resource status of neighbouring NG-RAN nodes
Energy efficiency
UE performance affected by the energy saving action (e.g. handed-over Ues), including bitrate, packet loss, latency.
System KPIs (e.g. throughput, delay, RLF of current and neighbouring NG-RAN node)
*****End Excerpt from 3GPP TR 37.817 V1.3.0*****

It should be considered that TR 37.817 also covers a use case where RAN nodes send feedback to the OAM system concerning system performance and model performance, relative to how an Artificial Intelligence (AI)/Machine Learning (ML) process is working. This use case is characterized by model training being hosted at the OAM.

Therefore, the feedback described above and signaled from one RAN node to another, is signaled to the OAM instead, as shown in the excerpt from clause 5.1.2.2 in TR 37.817 shown below (see steps 13 and 14):

In this solution, NG-RAN makes energy decisions using AI/ML model trained from OAM.
*****BEGIN Excerpt from 3GPP TR 37.817 V1.3.0*****
   5.1.2.2
Step 0: NG-RAN node 2 is assumed to have an AI/ML model optionally, which can provide NG-RAN node 1 with input information.
Step 1: NG-RAN node 1 configures the measurement information on the UE side and sends configuration message to UE to perform measurement procedure and reporting.
Step 2: The UE collects the indicated measurement(s), e.g., UE measurements related to RSRP, RSRQ, SINR of serving cell and neighbouring cells.
Step 3: The UE sends the measurement report message(s) to NG-RAN node 1.
Step 4: NG-RAN node 1 further sends UE measurement reports together with other input data for Model Training to OAM.
Step 5: NG-RAN node 2 (assumed to have an AI/ML model optionally) also sends input data for Model Training to OAM.
Step 6: Model Training at OAM. Required measurements and input data from other NG-RAN nodes are leveraged to train AI/ML models for network energy saving.
Step 7: OAM deploys/updates AI/ML model into the NG-RAN node(s). The NG-RAN node can also continue model training based on the received AI/ML model from OAM.
Note: This step is out of RAN3 Rel-17 scope.
Step 8: NG-RAN node 2 sends the required input data to NG-RAN node 1 for model inference of AI/ML-based network energy saving.
Step 9: UE sends the UE measurement report(s) to NG-RAN node 1.
Step 10: Based on local inputs of NG-RAN node 1 and received inputs from NG-RAN node 2, NG-RAN node 1 generates model inference output(s) (e.g., energy saving strategy, handover strategy, etc).
Step 11: NG-RAN node 1 sends Model Performance Feedback to OAM if applicable.
Note: This step is out of RAN3 scope.
Step 12: NG-RAN node 1 executes Network energy saving actions according to the model inference output. NG-RAN node 1 may select the most appropriate target cell for each UE before it performs handover, if the output is handover strategy.
Step 13: NG-RAN node 2 provides feedback to OAM.
Step 14: NG-RAN node 1 provides feedback to OAM.
   *****End Excerpt from 3GPP TR 37.817 V1.3.0*****

### SUMMARY

Certain aspects of the present disclosure and their embodiments may provide solutions to the aforementioned or other challenges. Embodiments of the present disclosure provide a system for rich feedback information to improve energy efficiency in a wireless communication system.

Embodiments of the present disclosure provide for a method performed by a second network node to provide feedback information to a network node of a wireless network, comprising receiving a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state. Responsive to receiving the request, the method can include monitoring the one or more performance metrics of the group of one or more wireless communication devices, to determine performance feedback information and providing the performance feedback information to the network node.

In another embodiment, a method performed by a network node to configure a power state of a first network node of a wireless network includes sending, to a second network node, a request to monitor one or more performance metrics of a group of one or more wireless communication devices, wherein the group of one or more wireless communications devices are in a coverage area associated with the second network node and are affected by a modification of the power state of the first network node from a first power state to a second power state different than the first power state, wherein the group of one or more wireless communication devices include at least one wireless communication device that was not handed over from the first network node to the second network node in association with the modification of the power state of the first network node to the second power state.

In another embodiment, a network node includes a memory that stores computer-executable instructions and a processor that executes the computer-executable instructions to perform operations. The operations can include receiving a request to monitor one or more performance metrics of a group of one or more wireless communication devices, wherein the group of one or more wireless communications devices are in a coverage area associated with the second network node and are affected by a modification of the power state of the first network node from a first power state to a second power state different than the first power state, wherein the group of one or more wireless communication devices include at least one wireless communication device that was not handed over from the first network node to the second network node in association with the modification of the power state of the first network node to the second power state. Responsive to receiving the request, the operations can also include monitoring the one or more performance metrics of the group of one or more wireless communication devices, to determine performance feedback information and providing the performance feedback information to a network node.

In another embodiment, a non-transitory computer-readable storage medium that includes executable instructions to cause a processor device of a network node to receive a request to monitor one or more performance metrics of a group of one or more wireless communication devices, wherein the group of one or more wireless communications devices are in a coverage area associated with the second network node and are affected by a modification of the power state of the first network node from a first power state to a second power state different than the first power state, wherein the group of one or more wireless communication devices include at least one wireless communication device that was not handed over from the first network node to the second network node in association with the modification of the power state of the first network node to the second power state. Responsive to receiving the request, the processor can also monitor the one or more performance metrics of the group of one or more wireless communication devices, to determine performance feedback information and provide the performance feedback information to a network node.

### BRIEF DESCRIPTION OF THE DRAWINGS

The accompanying drawing figures incorporated in and forming a part of this specification illustrate several aspects of the present disclosure, and together with the description serve to explain the principles of the present disclosure.

FIG. 1 illustrates one example of a wireless communications system in which embodiments of the present disclosure may be implemented;

FIG. 2 illustrates one example of a message sequence chart of a wireless communication system configured to modify a power state of a network node according to one or more embodiments of the present disclosure;

FIG. 3 illustrates one example of coverage map of a wireless communication system according to one or more embodiments of the present disclosure;

FIG. 4 illustrates another example of a message sequence chart of a wireless communication system configured to modify a power state of a network node according to one or more embodiments of the present disclosure;

FIG. 5 illustrates another example of a message sequence chart of a wireless communication system configured to modify a power state of a network node according to one or more embodiments of the present disclosure;

FIG. 6 illustrates another example of a message sequence chart of a wireless communication system configured to modify a power state of a network node according to one or more embodiments of the present disclosure;

FIG. 7 illustrates one example of a wireless communications system in which embodiments of the present disclosure may be implemented;

FIG. 8 illustrates one example of a network node in which embodiments of the present disclosure may be implemented;

FIG. 9 is a schematic block diagram that illustrates a virtualized embodiment of the radio access node according to one or more embodiments of the present disclosure;

FIG. 10 is a flowchart of a method to provide feedback to a network node of a wireless network according to one or more embodiments of the present disclosure; and

FIG. 11 is a flowchart of a method to configure performance monitoring and feedback reporting to a second network node of a wireless network according to one or more embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the present disclosure and will recognize applications of these concepts not particularly addressed herein. It should be understood that these concepts and applications fall within the scope of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a Third Generation Partnership Project (3GPP) network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Power State: In the description herein, a network node is configurable in one of two or more power states, each associated with a different amount of power consumption by the network node. The two or more power states include a normal or high power state in which the network node is not configured to apply any power reduction technique and a low power state in which the network node is configured to apply a power reduction technique (e.g., fully shut down, disable a cell(s), disable a carrier(s), transmit system information and reference signals only but no data, or the like). The two or more power states may further include one or more intermediate power states. In general, the lower the power state the less power is consumed by the network node. As used herein, a power reduction technique can improve the energy efficiency or energy savings of a network over a period of time. The amount of power consumed by any particular network node may fluctuate, and even with power reduction techniques applied, can be higher than at other times with no power reduction technique applied. Over time though, and across a plurality of network nodes covering a coverage area, a power reduction technique applied to one or more of the network nodes can result in an overall reduction in power utilized, thus improving the overall energy efficiency and energy savings of the radio access network.

Note that, in the description herein, reference may be made to the term “cell”; however, particularly with respect to Fifth Generation (5G) New Radio (NR) concepts, beams may be used instead of cells and, as such, it is important to note that the concepts described herein are equally applicable to both cells and beams.

There currently exist certain challenge(s). For simplicity of exposition (which does not limit the scope of the invention) the cell subject to deactivation is named “capacity cell” and the other cell is named “coverage cell.”

The capacity cell can be switched off or reconfigured (e.g., to operate with reduced capacity) at times of low or lower traffic demand to increase network energy efficiency. Even though a first node (associated with the capacity cell) can get feedback from the second node (associated with the coverage cell) regarding the performance (impact) of such cell shutdown/reconfiguration on handed-over Wireless Communication Devices (WCDs), it still is difficult to predict beforehand and/or evaluate afterwards the full impact/effect of a cell shutdown/reconfiguration. This is due to the following:

In some situations, the traffic demand (and consequently the load) in a coverage cell increases when WCDs in the vicinity of a capacity cell transition from idle/inactive mode back to connected mode while the capacity cell is not active (the same applies to WCDs which are not in the coverage area of the reconfigured cell). These WCDs are also impacted by the capacity cell shutdown/reconfiguration, but the first node cannot know about them or their performance impact. Moreover, when having several capacity cells, it can be difficult to know which capacity cell deactivation/reconfiguration contributed to the related Quality of Service (QoS) and/or Quality of Experience (QoE) degradation.

It is thus challenging to understand how a (capacity) cell deactivation and/or reconfiguration affects the performance of the in-vicinity WCDs. For example, for idle/inactive mode WCDs, it is not clear whether they would have been served by the deactivated/reconfigured cell.

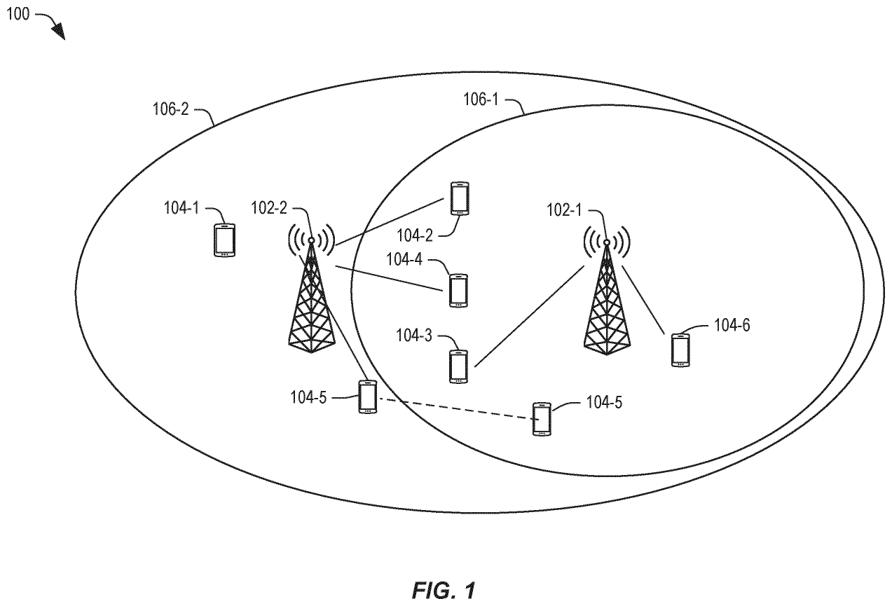

With reference to FIG. 1, which illustrates one example of a wireless communications system 100 in which embodiments of the present disclosure may be implemented, there can be a first network node 102-1 (e.g., the capacity cell) that serves coverage area 106-1 and a second network node 102-2 that serves coverage area 106-2. At one or another time, the network nodes 102-1 and 102-2 can serve WCDs 104-1, 104-2, 104-3, 104-4, 104-5, and 104-6 (collectively WCDs 104). In general, the different types of affected WCDs when deactivating/reconfiguring a capacity cell (e.g., coverage area 106-1) are:
1. Idle/inactive/connected mode WCDs (e.g., WCD 104-1) in cell 106-2 associated with second network node 102-2;
2. Connected mode WCDs (e.g., WCD 104-2) in first network node 102-1, to be handed over to second network node 102-2 upon deactivation or reconfiguration (e.g., reducing cell capacity) of first network node 102-1;
3. Connected mode WCDs (e.g., WCD 104-3) in first network node 102-1, not handed over to second network node 102-2 upon reconfiguration of first network node 102-1's cell (e.g., WCDs still served by first network node 102-1 after reducing cell capacity) as well as idle/inactive mode WCDs within first network node 102-1's original or changed coverage area, being connected to first network node 102-1 upon reconnection;
4. Idle/inactive mode WCDs (e.g., WCD 104-4) within first network node 102-1's original coverage area, being connected to second network node 102-2 upon reconnection (first network node 102-1's cell is deactivated/reconfigured);
5. Moving WCDs (e.g., WCD 104-5) in connected mode that would have been connected to the first network node 102-1 for part of their time in connected mode; and
6. Idle/inactive mode WCDs (e.g., WCD 104-6) within first network node 102-1's reconfigured coverage area 106-1, being connected to first network node 102-1 upon reconnection (first network node 102-1's cell is reconfigured).

Moreover, the capacity cell (e.g., first network node 102-1) can be re-activated or brought back to its original (e.g., maximum capacity) configuration when the traffic demand becomes higher; for example, when the load of the coverage cell (e.g., second network node 102-2) is above a certain level and there are users/WCDs in the vicinity of the capacity cell which can be moved to the capacity cell by handover or another procedure. Therefore, it is also important to understand when a certain capacity cell should be turned on or re-configured. However, it can be difficult to find out, e.g., if the WCDs served by the “basic” coverage cell (a cell overlapping with the capacity cell in part or in full) could be served by the capacity cell (or in multi-connectivity together with the capacity cell) before the capacity cell is re-activated.

With the existing technology the first network node 102-1 can only monitor the performance of WCDs labeled 3 and 6 in the list above (e.g., WCD 104-3 and 104-6) and learn about the performance of WCDs labeled 2 in the list above (e.g., WCD 104-2) from the second network node 102-2. Therefore, the first network node 102-1, or another node or entity responsible for the energy efficiency optimization, cannot sufficiently evaluate and improve the performance of the energy efficiency optimization process in charge of reconfiguring/deactivating (a) certain cell(s).

Certain aspects of the present disclosure and their embodiments may provide solutions to the aforementioned or other challenges.

In the present disclosure, for reasons of clarity and simplicity, the terms coverage cell, capacity cell, macro cell, booster cell, and similar denote different cells used to describe the methods without making any assumptions on those cell's capabilities. However, the methods can be applied to any type of cells, independently from the cell types used in the embodiment descriptions. In the embodiments, description of the main technique described is deactivation of a cell. This is just an example. Namely, instead of deactivation, the cell could be reconfigured in a number of different ways for the purpose of achieving energy efficiency improvements. As an example, the cell could be subject to carrier deactivation, without necessarily being fully deactivated.

The present disclosure comprises a framework to estimate and signal the performance impact of WCDs affected by a cell reconfiguration procedure for energy saving reasons (e.g., cell deactivation or potentially another energy saving procedure which affects a cell's coverage area).

In the disclosure, and as a non-limiting example, we mostly refer to the first network node 102-1 as the node serving the booster/capacity cell since it is more likely to be deactivated/reconfigured than a macro/coverage cell. The terms are merely used to simplify the description. However, the first network node 102-1 could also serve a macro cell and, for example, just deactivate/reconfigure one of its higher-frequency carriers to save energy.

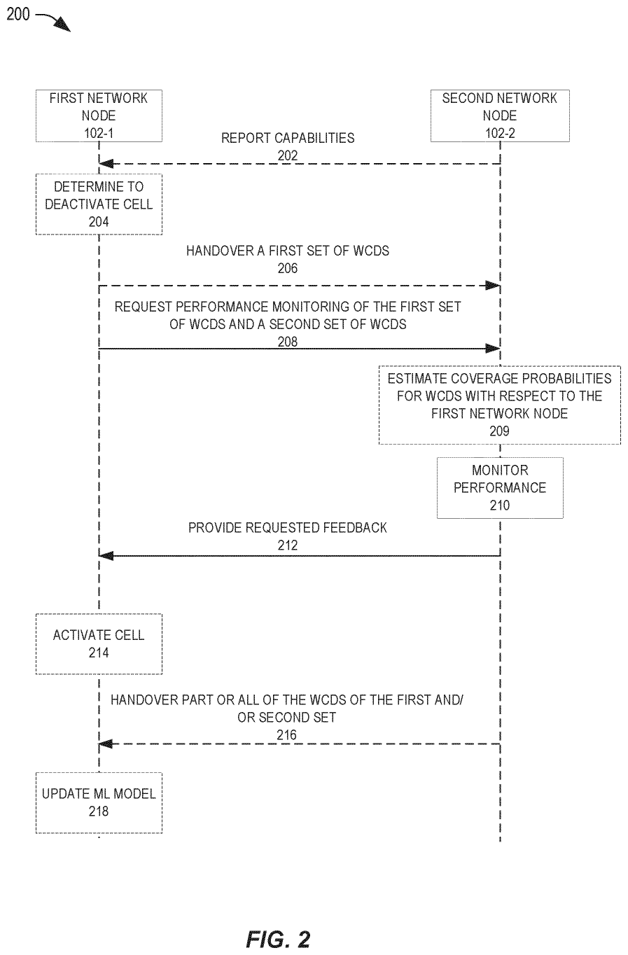

Turning now to FIG. 2, illustrated is one example of a message sequence chart 200 of a wireless communication system configured to modify a power state of a network node according to one or more embodiments of the present disclosure. It is to be appreciated that in this disclosure and in the figures, dashed lines represent optional steps and/or embodiments. Further, while the steps are shown in a particular order, the ordering of the steps may vary unless explicitly stated or otherwise required.

In the description herein, a network node is configurable in one of two or more power states each associated with a different amount of power consumption by the network node. The two or more power states include a first power state in which the network node is in a normal or high-power state. In the first power state, the network node is not configured to apply any power reduction technique. In a second power state, the network node can be in a different power state such as a low-power state in which the network node is configured to apply a power reduction technique (e.g., fully shut down, disable a cell(s), disable a carrier(s), transmit system information and reference signals only but no data, or the like). The two or more power states may further include one or more intermediate power states. In general, the lower the power state the less power is consumed by the network node, and in a higher power state, the more power is consumed by the network node. The normal (operation) power state of a node is when all the resources of the node are enabled for use in their most performing mode. For example, if the node can use 100% of the available bandwidth and power that its hardware and software allow, then this is the normal operation power state (independently of if it is using them or not). A reduced power state of a node is when some of its resources are not available.

At step 202, the second network node 102-2 may optionally signal to the first network node 102-1 its capabilities (e.g., a capability report) in identifying and monitoring different groups of WCDs, for example, if it supports probabilistic methods like coverage maps and/or secondary carrier prediction in order to predict whether a WCD belongs to the second set of WCDs.

At step 204, the first network node 102-1 can determine to deactivate the cell. In one or more embodiments, the determination to deactivate the cell can be made based at least in part on an Artificial Intelligence/Machine Learning (AI/ML) model. Note that while deactivation of the cell is used in this example, other types of reduced power states may be used (e.g., deactivating data channel transmissions only but maintaining reference signal transmissions, deactivating some carriers but not others, etc.). Thus, it is to be understood that deactivating the cell is only one of many possible ways that the first network node 102-1 may transition to a reduced power state.

Upon deciding to deactivate/reconfigure the capacity cell (step 204), e.g., using the AI/ML model, the first network node 102-1 can hand over (or initiate a reconfiguration from multi-connectivity to single connectivity for), at step 206, all or part of the active WCDs in its coverage (first set of WCDs) to the second network node.

Non-limiting examples of AI/ML techniques suitable for at least in part contributing to the determination to deactivate a cell are, for example, Reinforcement Learning (RL) and Supervised Learning (SL). In the first case, an RL agent observes different input Key Performance Indicators (KPIs), e.g., the load in the first and second network nodes, and other additional information, e.g., time of day. These, and potentially other, KPIs constitute the Environment of the RL agent, and by observing the Environment the RL agent determines a current State (t). Starting from that State the RL agent may perform one or a plurality of Actions, leading to the RL agent transitions to a new State, i.e., State (t+1). According to embodiments of the disclosure, an Action may be to determine to deactivate or not deactivate the cell. The RL agent then computes a Reward for said Action, expressing how beneficial performing said Action(s) was. According to embodiments of the disclosure, the Reward is calculated using other KPIs, e.g., energy saved at the first network node and increase in load in the second network node, to determine if it was a beneficial Action. Repeating this process multiple rounds, the RL agent learns in which situations and under what conditions the deactivation is beneficial. In the case of SL models, the same input KPIs may be used, but now there is a lengthy historical dataset with examples of the said KPIs; along the examples, there is an additional indication of when the deactivation was beneficial. The SL model analyzes the complete dataset to find patterns, i.e., combination of KPI values most frequently associated with a beneficial deactivation, and thus learns when the deactivation was beneficial.

At step 208, the first network node 102-1 can send a request to the second network node 102-2 to monitor the performance of the first set of WCDs that were handed over and a second set of WCDs. In one embodiment, the second set of WCDs comprises any WCD that might see its performance affected by the cell deactivation/reconfiguration and that it may not be known by the first network node, e.g., WCDs 104-1, 104-4, and 104-5. In case some WCDs remain served by the first network node (e.g., in case of reduction in cell capacity), the said node can also monitor the performance of these WCDs (e.g., WCDs 104-3 and 104-6).

At step 209, the second network node 102-2 can estimate the coverage probabilities for WCDs with respect to the first network node 102-1 in order to determine which WCDs should be in the second set of WCDs. In some embodiments, the second network node 102-2 can estimate the coverage probabilities of the group of one or more wireless communications devices that are affected by the modification of the power state of the first network node 102-1 to a reduced power state (or second power state) based on a probability of the wireless communications devices of the group of one or more wireless communication devices 104 being served by the first network node 102-1, if the first network node 102-1 were in a normal, full (or fourth) power state, exceeding a predefined threshold.

At step 210, the second network node 102-2 monitors the performance of the selected WCDs and then proceeds to provide the requested feedback back to the first network node 102-1 at step 212 or to another (network) node or external system in charge of evaluating the performance of the AI/ML process, e.g., the Operations, Administration and Management (OAM) system. The feedback could be sent only once or updated multiple times, upon expiration of a timer or another triggering condition, or by explicit signaling from the first network node, e.g., upon request.

The first network node 102-1 may decide, upon reception of the feedback, to activate/reconfigure the capacity cell at step 214, which could potentially trigger handovers (or the reconfiguration to multi-connectivity) of several WCDs from the second network node (step 216).

The first network node 102-1 and any other system receiving the feedback use the feedback to update the AI/ML model used to take energy saving decisions at step 218.

Certain embodiments may provide one or more of the following technical advantage(s). The solution allows a network node/system to obtain more detailed feedback related to the overall performance impact of a decision to deactivate/reconfigure a cell. While the existing technologies only look at how the performance of handed-over WCDs are affected by the energy saving action, the present solution provides a more accurate/complete feedback information on the performance impact of the cell deactivation/reconfiguration. In particular, it also considers 1) the WCDs that could have been served by the first network node had it not deactivated/reconfigured its cell; and 2) any other connected WCD served by the coverage cell which might be impacted by the deactivation/reconfiguration of the capacity cell. This more detailed feedback can enable a better understanding of the trade-off between energy saving and service performance of energy saving actions, which can be used, for example, in the training or updating of an AI/ML model.

With regard to the estimation step 209, the second network node 102-2 may optionally signal (e.g., in step 202) to the first network node 102-1 its capabilities in identifying and monitoring different groups of WCDs, for example, if it supports probabilistic methods like coverage maps and/or secondary carrier prediction in order to predict whether a WCD belongs to the second set of WCDs. The first network node 102-1 can consider these capabilities when determining if it will shut down the capacity cell completely or if it will only partially reconfigure the capacity cell or if it will leave the cell partially activated to still send certain system information and reference signals on which the WCDs can measure Reference Signal Received Power (RSRP), Reference Signal Received Quality (RSRQ), etc., and report measurements to the second network node 102-2, which can then know whether a WCD belongs to the second set of WCDs. The second network node 102-2 may further signal to the first network node 102-1 its capabilities in collecting different performance metrics and providing feedback reports.

With regards to steps 204 and 206, the capacity cell can be deactivated/reconfigured and feedback information retrieved in subsequent steps. For example, the first network node 102-1's AI/ML model can learn to deactivate/reconfigure the cell given a certain network load and time of day.

Before deactivating/reconfiguring the capacity cell, the first network node 102-1 may transfer part/all active WCDs (e.g., WCD 104-2) to the coverage cell. The following paragraphs describe the invention assuming a single connectivity scenario; thus, the active WCDs are handed over to the second network node 102-2. However, in a multi-connectivity scenario, some WCDs are simultaneously connected to the first network node 102-1 and the second network node 102-2.

Alternatively, during the deactivation/reconfiguration process, the first network node 102-1 can release part of the WCDs in RRC_CONNECTED state but not engaged in data transfer (releasing them to RRC_IDLE or to RRC_INACTIVE state) or reject ongoing attempts of WCDs to transition from RRC_IDLE or RRC_INACTIVE to RRC_CONNECTED. There can be different methods for detecting ongoing data transfer to/from a WCD, e.g., by means of monitoring the transmission and/or reception of data packets to/from the WCD, ongoing RRC procedures for the WCD, the transmission of scheduling grants to the WCD, reception of lower layer (e.g., MAC layer) indications from the WCD, an ongoing Random Access (RA) procedure for the WCD. In a variant of the alternative, the WCDs are released and redirected to another frequency or another Radio Access Technology (RAT).

The first network node 102-1 can request the second network node 102-2 to monitor the performance of handed-over WCDs (e.g., WCD 104-2). This can be done simultaneously or after the handover procedure (or the reconfiguration from multi-connectivity to single connectivity for WCDs in a multi-connectivity setup).

The first network node 102-1 can also request the second network node 102-2 to monitor the other potentially affected WCDs (WCDs 104-1, 104-4, and 104-5). In the case of WCDs that become active in the coverage area 106-1 after the cell has been deactivated/reconfigured, the second network node 102-2 can determine that a WCD is inside the coverage area 106-1 using probabilistic or deterministic (e.g., reference-signal-based) methods. A non-exhaustive list of these methods is listed in the paragraphs below.

The first network node 102-1 can also monitor the performance of the WCD 104-3 and 104-6. Such performance can be used by the first network node or signaled to another network node or external system such as the OAM.

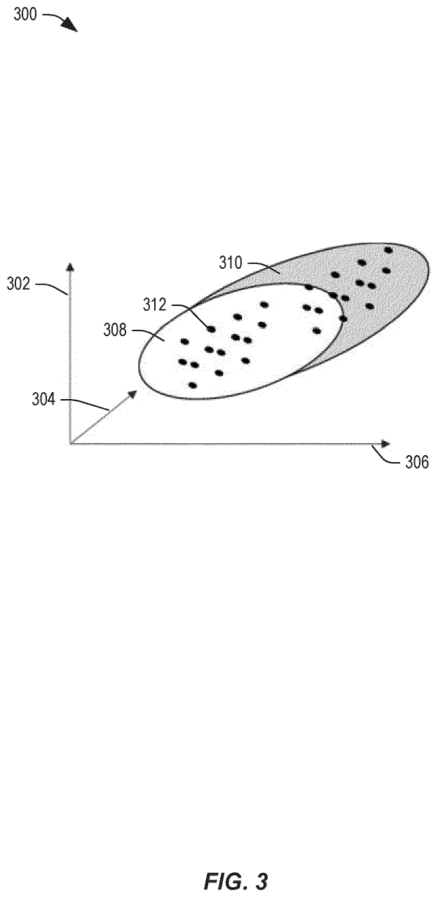

Turning now to FIG. 3, illustrated is one example of coverage map 300 of a wireless communication system according to one or more embodiments of the present disclosure.

The probability that a WCD would be served by the deactivated/reconfigured cell can be estimated by the second network node 102-2 by comparing the coverage maps of the first network node's cell before and after deactivation/reconfiguration. The coverage maps comprise the radio measurements 302, 304, and 306 of multiple devices 312. A base station (e.g., second network node 102-2) generally uses reference signals to obtain measurements performed by the WCDs on the beams transmitted by a base station, e.g., to assess the quality of the beams. In general, the reference signals transmitted by at least one base station to a WCD may comprise at least one of a Channel State Information Reference Signal (CSI-RS), a Synchronization Signal Block (SSB), a Primary Synchronization Signal (PSS), a Secondary Synchronization Signal (SSS), and a Cell Specific Reference Signal (CRS). More specifically, a WCD may assess reference signal beam levels of coverage, quality, and interference via measurements on the SSB (e.g., corresponding to a Synchronization Signal/Physical Broadcast Channel (PBCH) block) in a 5G (e.g., NR) network, or via measurements on the CSI-RS resources in a 5G (e.g., NR) network or a Fourth Generation (4G) (e.g., Long Term Evolution (LTE)) network.

In the present disclosure, the radio measurements may correspond to signal quality feedback on the above reference signals, for example the RSRP, RSRQ, or Signal to Interference & Noise Ratio (SINR). The radio measurement may also comprise the cell Identifiers (IDs) of the hearable cells. The radio measurements may also comprise timing advance or beamforming information such as the Precoder Matrix Index (PMI). The radio measurements may also comprise radio signal quality measurements on uplink signal from the WCD, e.g., a Sounding Reference Signal (SRS).

To derive the probability of a WCD being connected and served by a capacity cell, a network node could build two coverage maps: one coverage map 308 before the capacity cell deactivation/reconfiguration, and one coverage map 310 after that (or in general before and after applying energy efficiency decisions). The coverage maps can be created either by using Minimization of Drive Test (MDT) measurements (including early measurements) or even by Radio Resource Management (RRM) measurements provided by connected-mode WCDs. Then, by using some estimation method (e.g., ML prediction) the second network node 102-2 could use the new measurements of a WCD and the two coverage maps 308 and 310 to predict the probability that the WCD might have been served by the capacity cell had it not been deactivated/reconfigured.

In terms of radio measurements, this can be visualized according to FIG. 3, where the devices 312 with the radio measurements in coverage area 310 are assumed to belong to the second set of WCDs that are the WCDs that could be impacted by a power state modification in the first network node 102-1.

In order to detect a node on another frequency using target carrier prediction, the WCD performs signaling of source carrier information, where a mobile WCD periodically transmits source carrier information to enable the macro node to handover the WCD to another node operating at a higher frequency. Using target carrier prediction, the WCD does not need to perform inter-frequency measurements, leading to energy savings at the WCD. However, frequent signaling of source carrier information that enables prediction of a secondary frequency can lead to an additional overhead and should thus be minimized. The risk of not performing frequent periodic signaling is missing an opportunity of doing an inter-frequency handover to a less-loaded cell on another carrier. The WCD can instead receive the model and use source carrier information as input to the model, which then triggers an output indicating coverage on the secondary carrier cell.

In respect to the present disclosure, the WCD could in one embodiment be configured with such an ML model, able to translate the measured radio measurements, to a predicted coverage on the deactivated first network node 102-1. This enables the network to get frequent probability estimates on the potential WCD coverage on the first network node 102-1, since it can execute the model whenever it experiences a new radio measurement. In contrast to when the radio measurements need to be signaled to its serving second node. This could also be useful for WCD 104-5 to allow for multiple probabilities to be estimated during its traffic flow. This is further exemplified in the figure below. Note that this would be equally valid for WCD 104-4.

### Partially Deactivated Cell

In one embodiment, the cell is not deactivated in full, but instead its capacity has been reduced. In one example, the cell has no user plane capacity, however it still sends certain system information and reference signals, e.g., PBCH and SSBs (or even CSI-RS) on which the WCDs can measure RSRP/RSRQ/etc. and report the measurements to the second network node 102-2.

This approach has the advantage that the second network node 102-2 knows with high certainty which WCDs would have been served by the first network node 102-1 had it not deactivated/reconfigured its cell.

Equivalently, the above applies if the capacity cell is reconfigured to serve only a portion of its original capacity, e.g., by deactivating only some of its carriers. In this case the overall coverage of the capacity cell would remain unaltered.

In case the cell has no user plane capacity (i.e., only control channels are usable), the first network node 102-1 may, for example, mark the cell as barred in the Master Information Block (MIB) to prevent WCDs to camp on the capacity cell. A cell in this state is not completely shut down, and thus still consumes some power.

In one alternative to the approach described above, the capacity cell served by the first network node 102-1 is fully deactivated and does not regularly transmit essential system information and reference signals, e.g., PBCH and SSBs, so that the WCDs cannot measure RSRP, RSRQ, etc. at any point in time. This approach is particularly suitable if the need to offload WCDs and associated user traffic from the coverage cell served by the second network node to the capacity cell served by the first network node arises infrequently, or, in other words, if the probability of such offloading need is relatively low, e.g., at night times.

In this case, the second network node 102-2 may trigger or request the first network node 102-1 to temporarily transmit one or more reference signals, e.g., SSBs, at a certain time and/or for a certain period in one or more cells (or beams) served by the first network node 102-1. Regarding the example discussed herein, the second network node 102-2 may trigger the first network node 102-1 to transmit, e.g., SSBs, in the (capacity) cell served by the first network node 102-1 and configure one or more WCDs currently served by itself to measure and report RSRP, RSRQ, etc. for the said cell.

This approach also has the advantage that the second network node 102-2 knows with high certainty which WCDs would have been served by the first network node 102-1 had it not deactivated its cell, but compared to the approach mentioned above, it has the advantage of enabling even further Network (NW) energy savings due to full deactivation of the said cell.

The second set of WCDs can also be defined based on the WCDs reconnection or handover or reconfiguration from single connectivity to multi-connectivity at the cell activation in step 214 in FIG. 2. In case the capacity cell is deactivated and then reactivated, once the WCDs can measure the received signal strength of the activated cell, measurements can be used to determine a second group of WCDs retrospectively. This method is feasible if the requested feedback from the second network node 102-2 is reported after cell activation (not shown in FIG. 2). This method enables the identification of part of the WCDs listed as 104-4 and 104-5, namely the identification of active WCDs that reside in the coverage area of the capacity cell but are served by the coverage cell (right) before the capacity cell is being reactivated.

Returning to FIG. 2, the first network node 102-1 can request the second network node 102-2 to monitor the performance of handed-over WCDs using the handover request message or a new message. In other words, steps 206 and 208 could be merged in case of the handed-over WCDs.

In another embodiment, in order to monitor a “first set of WCDs” and/or the other potentially affected WCDs (“second set of WCDs”), the first network node 102-1 may use a NG-RAN node configuration update message over a Xn interface (which is already used to indicate that a cell was switched off to lower energy consumption) or a new message not standardized yet or additions to an existing procedure. In general, the procedure used may occur on any available interface between the first and second network nodes.
The request for performance monitoring and subsequent feedback message may include any of the following:
Which individual WCDs or groups of WCDs to monitor, or namely whether to monitor a first and/or a second set of WCDs.
At least one indication of which WCDs belong to the second set of WCDs, in case the second network node 102-2 uses probabilistic methods to distinguish whether a WCD would have been inside or outside of the coverage area of the deactivated cell, such indication can be:
   The probability that a WCD would have been in coverage is above a certain threshold.
      This probability may be specified as average, max, min, quantiles, or other statistics during the monitoring and/or reporting period.
   The probability that a WCD would have been out of coverage is below a certain threshold.
If the WCD performance monitoring and reporting should be done per individual WCD or per group of WCDs
   If the performance metric should be an average value, min/max interval, quantiles, or another statistic during the monitoring period.
   In the case of group monitoring, if the performance metric should be an average value, min/max interval, quantiles, or another statistic per group.
   If multiple indications of which WCDs belong to the second set of WCDs are given, if the performance metrics should be monitored and reported together or separately for the different subsets of the second set of WCDs defined by the different indications.
      For example, separately for WCDs that are likely in coverage and out of coverage of the deactivated cell.
Which performance metrics to monitor and report.
   If the report should include the performance metrics and/or a function of them, e.g., as sum or product, and, optionally, after applying provided coefficients and/or exponents.
If the reporting should be done to the first network node 102-1, to an external system such as the OAM, or to another node.
The period over which WCD performance monitoring should be done, for example:
   A fixed or configured period (e.g., 30 seconds).
      In case the requested feedback comprises feedback reported by the WCD, the period can be regulated by, e.g., a configuration parameter (e.g., a timer) signaled from the first network node 102-1 to the WCD as part of an RRC reconfiguration message sent to WCD during a handover procedure (or, for WCDs in a multi-connectivity setup, as part of an RRC reconfiguration message sent to WCD during a multi-connectivity-related procedure). Alternatively, said configuration parameter may be signaled from the second network node 102-2 to the WCD(s) after the handover(s) or multi-connectivity-related procedure(s). Similarly, it must be signaled from the second network node 102-2 to a WCD upon becoming active in the coverage cell.
   Until a certain triggering event happened or until a certain procedure is initiated or completed (e.g., capacity cell was re-activated, a subsequent handover is started or completed, a subsequent reconfiguration—for example from single connectivity to multi-connectivity—is started or completed)
   Until the second network node 102-2 receives a stop indication (for example, from the first network node 102-1 or another node);
The time at which WCD performance reporting should be done, for example:
   At a certain periodicity (e.g., every second)
   After a certain time has elapsed (e.g., after 30 seconds)
   Once a certain triggering event happened (e.g., capacity cell was re-activated); and/or
   Upon request from the first network node or another node (once or multiple times)

The performance being monitored at step 210 can comprise WCD energy consumption or battery level, bitrate, latency, reliability performance, etc. A certain degradation in performance regarding energy consumption, bitrate, latency, reliability, etc. is not necessarily reflected in a degradation in user satisfaction, e.g., QoE. Maintaining the same or a similar quality of service of handed-over WCDs at the second network node 102-2 while performing energy saving actions at the first network node 102-1 may not be needed, as WCDs may be over-provisioned at the first network node 102-1 with respect to the current application or service, e.g., Dynamic Adaptive Streaming over HTTP (DASH) streaming. It may therefore lead to incomplete exploitation of the energy saving potential. To facilitate the best possible energy saving strategies, reporting of RAN Visible Quality of Experience (RVQoE) metrics or values for handed-over WCDs to the second network node 102-2 from the first network node 102-1 can be beneficial when applicable.

The WCD performance metrics may comprise:
Bitrate (average, min, max, quantiles);
Latency (average, min, max, quantiles);
Packet loss statistics;
Jitter; and/or
RAN visible QoE measurements.

The WCD energy-related metrics may comprise:
A metric indicated as absolute values (for power consumption, remaining power, energy consumption, energy efficiency, etc.). Some non-limiting examples are power level in mW, energy consumption in Joule, energy efficiency in Joule per bit;
A metric indicated as percentage values (for power consumption, remaining power, energy consumption, energy efficiency, etc.), wherein a value (e.g., 0) indicates a minimum level and another value (e.g., 100) indicates a maximum level;
A metric indicated as relative increase or decrease, compared to a reference, wherein a positive value indicates an increase of the metric (or vice versa) and a negative value indicates a decrease of the metric (or vice versa). For example, a positive value X_1 can indicate that the energy efficiency has increased (positive effect) compared to a reference value of X_ref; or a positive value Y_1 can indicate that the energy consumption has increased (negative effect) compared to a reference value of Y_ref;
   The relative increase or decrease can be in absolute values or in percentages;
A metric indicated in qualitative sense for at least one of the power or energy metrics. For example, a scalar indicating if the energy efficiency is considered as good, medium, poor;
A score value (measured, estimated, or predicted) associated to one or more WCD operations/functions that the WCD is configured to perform;
A delta/offset value for a measurement, estimate, or prediction with respect to a reference value, wherein the value may refer to:
   An actual measurement, estimate, or prediction;
   A score value;

In one embodiment of this invention the performance metrics are provided with the following granularity:
Per QoS Flow;
Per PDU Session;
Per radio bearer (e.g., per DRB); and/or
Per WCD.

The metrics may be collected by the network node serving the WCD (e.g., second network node 102-2) or may be provided by the WCD to the network node, for the network node to report them to the node that has been configured as the performance metrics destination. A combination of both methods, where some metrics are provided by the WCD and some by the network node may be also possible.

WCDs in the first and/or second set of WCDs might initiate new applications or services during the period in which their performance is monitored by the second network node 102-2; similarly, WCDs that are monitored by the first network node 102-1 after a cell reconfiguration might initiate new applications or services. The QoS requirements for these new services and their energy performance shall also be accounted for in the feedback step 212 that might include WCD application classification and their corresponding network requirements.

At step 212, feedback may be collected by both the first network node 102-1 and second network node 102-2. As an example, the first network node 102-1 may collect feedback for WCDs that are served by a reconfigured cell, e.g., WCDs 104-3 and 104-6. In general, feedback may be either signaled to the first network node 102-1, to an external system such as the OAM, or any other (network) node.

In an embodiment, the feedback may further include the number of WCDs included in the first and/or second set of WCDs (or any other grouping) as well as the user data traffic characteristics, such as user data traffic volume associated with those WCDs, aggregated for all WCDs or separately for each WCD, or as statistics for each WCD, or for a subset of WCDs, or the entire set of WCDs, such as maximum, minimum, average, quantiles, etc., for a certain period of time. Similarly, other traffic characteristics, such as statistics of inter-arrival time of data packets or data bursts, may be included in the feedback.

In one example, the above information can be leveraged by the first network node 102-1 or another network node, or an external system or entity, to make a more informed decision on whether to revert or modify the previously executed energy saving action and, if so, what action to take next (step 214). Similarly, the above information can be used to further improve the AI/ML model.

When feedback is signaled from the second network node 102-2 to the first network node 102-1, the second network node 102-2 may send the feedback using any available interface between the first network node 102-1 and second network node 102-2. As an example, an Xn cell activation request message may be used or additions may be applied to any existing message, or a new message not yet standardized may be used. The Xn cell activation request message may, for example, be used by the second network node 102-2 in case it detects a severe degradation of the performance of one or more WCDs after the cell deactivation; in this way, it provides both the feedback and signaling to turn on the deactivated cell.

At step 214, the first network node 102-1, upon receiving feedback from the second network node 102-2 on the first and second set of WCDs or due to the monitoring of WCDs served by its own capacity cell, might determine that the actions or part of the actions executed based on the outcome of step 204 resulted in a negative outcome; either in terms of the QoS/QoE or in any of the reported energy metrics. The outcome of such a decision would be to revert or modify the previous energy saving action (step 214), which could lead to a reconfiguration of a part of or all the WCDs that were affected in steps 204-206 (step 216).

At step 218, the first network node 102-1 or any other system receiving the feedback information, such as the OAM, can update the AI/ML model based on the received feedback. For example, if the same network state (e.g., number of connected WCDs in the capacity cell and coverage cell, radio resource utilization or status at the capacity cell and coverage cell, WCD types/models, user data traffic types and volume, time-of-day, etc.) is seen in a future time instance, the first network node may not deactivate the capacity cell in case many WCDs in the second set of WCDs had a bad performance and/or an unsatisfactory user experience (e.g., RAN visible QoE).

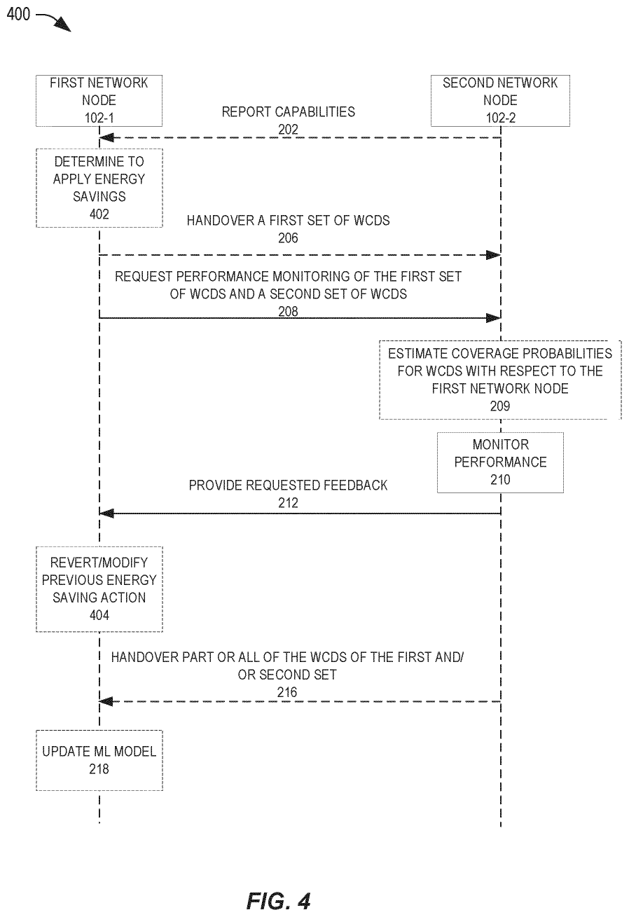

Turning now to FIG. 4, illustrated is another example of a message sequence chart 400 of a wireless communication system configured to modify a power state of a network node according to one or more embodiments of the present disclosure. The previous embodiments cover the scenario where the first network node 102-1 decides to deactivate the capacity cell (step 204). However, any embodiment where energy saving actions that reduce or remove part of or all the coverage of a cell (herein called capacity cell) is possible. Here, the first network node 102-1 can determine to apply an energy saving protocol/cell reconfiguration at step 402. A cell reconfiguration will affect WCDs under its coverage due to, e.g., 1) poorer performance towards WCDs served by the cell; 2) poorer performance towards WCDs served by cells receiving traffic offloads as a consequence of the reconfiguration.

In a possible scenario, the first network node 102-1 may decide to reduce the transmitter power output of the capacity cell for energy saving reasons at step 402. This action effectively reduces the geographical area covered by the capacity cell. After the power output is reduced, WCDs which were located close to the edge of the original coverage area of the capacity cell may still be able to receive certain system information and reference signals, e.g., PBCH and SSBs (or CSI-RS). However, these WCDs may experience an unacceptably low SINR and connectivity problems if they remain served by and connected to the capacity cell, or if they keep camping on and reconnect to the capacity cell.

Regarding the above-mentioned WCDs, those WCDs that are active at the time of transmit power reduction should be handed over to the second network node (step 206) before the first network node reduces the transmit power of the capacity cell, i.e., these WCDs are included in the first set of WCDs. Similarly, those WCDs which are inactive or idle at that time would reselect and camp on the coverage cell served by the second network node, which means that these WCDs are part of the “second set of WCDs.”

In the same scenario, the first network node 102-1 may signal to the second network node 102-2 (in step 208) the reduction in transmitter power output (e.g., in watt or dB), for example, reusing signaling over any available interface between the RAN nodes, for example using a Xn: NG-RAN NODE CONFIGURATION UPDATE message or using a new message not standardized yet or adding information to any other standardized message. In case a WCD becomes active in the coverage cell, the second network node 102-2 may use this information, along with the WCD's reported measurements of the capacity cell's reference signals, to determine if said WCD would/could have been served by the capacity cell had it not reduced its power output by the signaled amount.

In another possible scenario, the first network node 102-1 may turn off some of the antenna elements used by the capacity cell, which also changes (e.g., reshapes) the coverage area of the capacity cell. Like in the above scenario, WCDs that were located close to the edge of the former coverage area of the capacity cell may now experience an unacceptably low SINR and connectivity problems due to the decreased beamforming gain. Those WCDs that are active at the time of antenna element shutdown and located in areas with lost coverage are part of the “first set of WCDs,” whereas those WCDs which are inactive or idle at that time are part of the “second set of WCDs.”

In the latter scenario, the first network node 102-1 may indicate to the second network node 102-2 (in step 208) the change in number of antenna elements used by the capacity cell, which also implies a potential change in the coverage area of the capacity cell, for example, reusing the Xn: NG-RAN NODE CONFIGURATION UPDATE message or with a new message not standardized yet. The second network node 102-2 may then use this information to distinguish whether a WCD would/could have been served by the capacity cell had it not reduced the utilized number of antenna elements.

If, as in those cases, the capacity cell is not deactivated completely and some WCDs remain served by the first network node 102-1 (or connect to it after the energy saving action was taken), the first network node 102-1 may monitor the performance of the served WCDs. The first network node 102-1 may transmit this performance to another (network) node or to external systems. The first network node 102-1 can also use such information, potentially along with the feedback received from the second network node 102-2 (in step 212) to revert or modify the previously taken energy saving action, e.g., to apply a new and more optimal/suitable energy saving action (step 404). For example, the first network node 102-1 may decide to slightly increase the transmitter power output to an intermediate power state (e.g., a third power state) that is higher than the reduced power state (e.g., a second power state), but lower than the normal power state (e.g., a first power state) or to turn on some of the previously turned-off antenna elements. This may cause some WCDs to reconnect to, or to be handed over to, or be reconfigured from single connectivity to multi-connectivity with the capacity cell (step 216).

In a multi-connectivity scenario, a WCD could be connected to two network nodes, a Master Node (MN) (e.g., second network node 102-2) and a Secondary Node (SN) (e.g., first network node 102-1). Analogously to what has been discussed above, the SN can decide to apply some energy saving action, for example, turning off or decreasing the transmit power of the capacity cell.

In a possible scenario, the first network node 102-1 can be, e.g., SN of a multi-connectivity setup and the second network node 102-2, a MN of the same multi-connectivity setup. Upon determining (in step 204) to, e.g., deactivate a cell (herein called capacity cell), the SN initiates (in step 206) an SN Release procedure to release the WCD context and corresponding resources at the SN for all affected WCDs in multi-connectivity. These WCDs, and any other WCD which was connected to the first network node 102-1 in single connectivity and was handed over to the second network node 102-2 prior to the cell deactivation, constitute the “first set of WCDs.” In another example, in case of reconfiguration of the first network node 102-1 (e.g., because of reduction of the cell capacity at the first network node), then a possible action could be bearer type change to MN terminated Master Cell Group (MCG) bearers for some WCDs.

If the capacity cell served by the first network node 102-1 (i.e., SN) is reactivated (in step 160), the second network node 102-2 (i.e., MN) can initiate a multi-connectivity procedure to reconfigure WCDs from single connectivity to multi-connectivity, e.g., the MN can trigger a SN Addition procedure. In the case that the first network node was reconfigured before (e.g., the cell capacity at the first network node 102-1 was earlier reduced), then upon increasing the cell capacity again, a bearer type change from MN terminated MCG bearers to SN terminated SCG bearers and/or split bearers could take place for some WCDs.

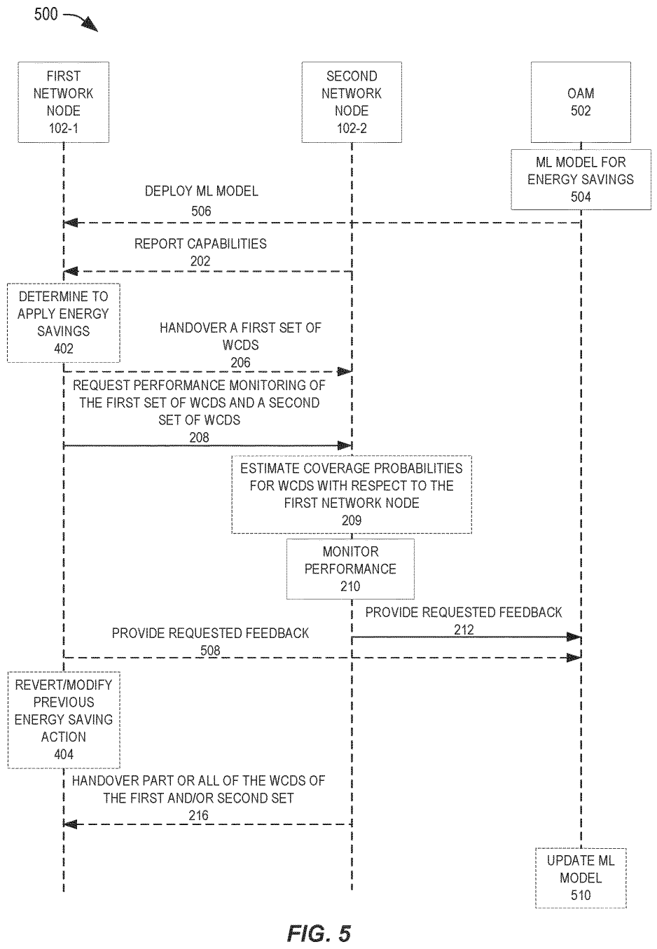

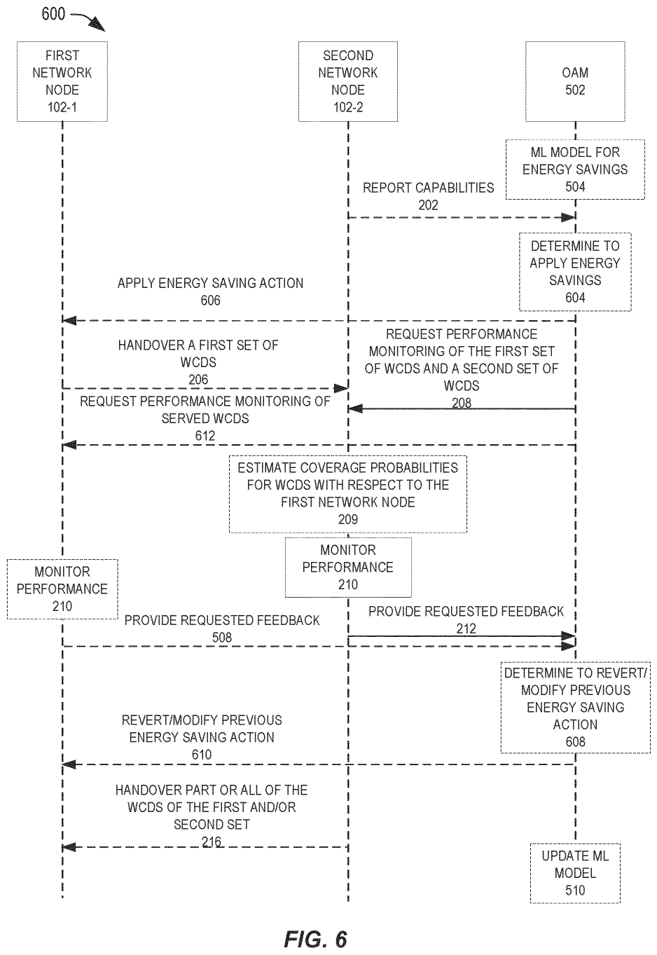

Turning now to FIGS. 5 and 6, illustrated are other examples of a message sequence chart 500 and 600 of a wireless communication system configured to modify a power state of a network node according to one or more embodiments of the present disclosure.

The previous embodiments mainly describe the case where the feedback is received by the first network node 102-1. However, the feedback may be received by another (network) node or an external system or entity, such as the OAM 502. This is beneficial if, e.g., the other node or system employs the feedback to update an AI/ML model.

FIG. 5 and FIG. 6 depict two possible realizations of this situation, where the difference lies in where the energy saving action is taken. In FIG. 5, the energy saving action is taken in the first network node 102-1, whereas in FIG. 6, it is the external system who takes the action and signals this to the first network node 102-1. It is to be appreciated that in FIGS. 5 and 6, the third network node depicted is an OAM 502, but in other embodiments, another network node or function can perform similar or comparable functions as described herein with reference to OAM 502.

In an embodiment, the OAM 502 can possess an AI/ML model that provides energy saving actions directed at the first network's node cell (step 504). This model could potentially be deployed in the first network node at step 506 or used in the external system or entity directly (FIG. 6). After deploying in step 506 the ML model to the first network node 102-1, the first network node 102-1 can determine whether to apply energy savings or reconfigure the cell based at least in part on the ML model, and send a request to monitor the performance at 208 of the first set of WCDs handed over (if any) to the second network node 102-2 as well as any other WCDs that might be affected by the power state modification at the first network node 102-1. At 612, the OAM 502 can optionally also request to monitor the performance of WCDs still being served by the first network node 102-1. In an embodiment, both the first network node 102-1 and the second network node 102-2 can provide the requested feedback to the OAM 502 at steps 508 and 212, respectively. The OAM 502 can use that information to update the ML model at step 510.

In FIG. 6, since the energy savings action is taking place at the OAM 502, the OAM 502 can determine whether to apply energy savings based on the ML model at step 604. At step 606, the OAM 502 can send instructions that facilitate reconfiguring the first network node 102-1. Based on the requested feedback received from the first network node 102-1 and the second network node 102-2 at step 508 and step 212 respectively, the OAM 502 at step 608 can determine whether to revert or modify the previous energy saving actions implemented at the first network node 102-1. The OAM 502 can then send instructions to the first network node 102-1 at step 610 to apply the reversion or modification of the energy savings action, and the OAM 502 can also update the ML model 510.

When feedback is signaled from network nodes to external systems or entities (e.g., the OAM 502), feedback information may be signaled (steps 508 and 212) using options such as:
Performance Measurements and KPI reporting over an interface between RAN and external system or entity (e.g., the RAN-OAM interface);
MDT measurement reports; and/or
Streaming of information from the RAN to the external system or entity (e.g., OAM).

With the collected feedback, the external system or entity may update the AI/ML model for energy saving (step 510).

In one alternative, the external system or entity is a Service Management and Orchestration (SMO) automation platform, or a comparable network automation platform, or a non-/near-real time RAN Intelligent Controller (RIC), or a comparable network automation controller, or an rApp or xApp running on a non-/near-real time RIC, or one or more comparable network applications. According to alternatives, the external system may also be implemented as a cloud deployment or as a function provided in an Open RAN, O-RAN.

### Implementation Examples

In the tables below, which are adopted from TS 38.423 v16.7.0, the additional portions that are disclosed herein, and not included in TS 38.423 v16.7.0 are underlined.

Xn: NG-RAN NODE CONFIGURATION UPDATE. This message is sent by a NG-RAN node to a neighboring NG-RAN node to transfer updated information for an Xn-C interface instance.

Direction: NG-RAN node 1→NG-RAN node 2.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| TAI Support List | O | | 9.2.3.20 | List of | GLOBAL | reject |
| | | | | supported TAs | | |
| | | | | and associated | | |
| | | | | characteristics. | | |
| CHOICE Initiating Node Type | M | | | | YES | ignore |
| >gNB | | | | | | |
| >>Served Cells To Update | O | | 9.2.2.15 | | YES | ignore |
| NR | | | | | | |
| >>Cell Assistance | O | | 9.2.2.17 | | YES | ignore |
| Information NR | | | | | | |
| >>Cell Assistance | O | | 9.2.2.43 | | YES | ignore |
| Information E-UTRA | | | | | | |
| >ng-eNB | | | | | | |
| >>Served Cells to Update | O | | 9.2.2.16 | | YES | ignore |
| E-UTRA | | | | | | |
| >>Cell Assistance | O | | 9.2.2.17 | | YES | ignore |
| Information NR | | | | | | |
| >>Cell Assistance | O | | 9.2.2.43 | | YES | ignore |
| Information E-UTRA | | | | | | |
| TNLA To Add List | | 0 . . . 1 | | | YES | ignore |
| >TNLA To Add Item | | 1 . . . | | | — | |
| | | <maxnoofTNLAssociations> | | | | |
| >>TNLA Transport Layer | M | | CP | CP Transport | — | |
| Information | | | Transport | Layer | | |
| | | | Layer | Information of | | |
| | | | Information | NG-RAN node₁ | | |
| | | | 9.2.3.31 | | | |
| >> TNL Association | M | | 9.2.3.84 | | — | |
| Usage | | | | | | |
| TNLA To Update List | | 0 . . . 1 | | | YES | ignore |
| >TNLA To Update Item | | 1 . . . | | | — | |
| | | <maxnoofTNLAssociations> | | | | |
| >>TNLA Transport Layer | M | | CP | CP Transport | — | |
| Information | | | Transport | Layer | | |
| | | | Layer | Information of | | |
| | | | Information | NG-RAN node₁ | | |
| | | | 9.2.3.31 | | | |
| >> TNL Association | O | | 9.2.3.84 | | — | |
| Usage | | | | | | |
| TNLA To Remove List | | 0 . . . 1 | | | YES | ignore |
| >TNLA To Remove Item | | 1 . . . | | | — | |
| | | <maxnoofTNLAssociations> | | | | |
| >>TNLA Transport Layer | M | | CP | CP Transport | — | |
| Information | | | Transport | Layer | | |
| | | | Layer | Information of | | |
| | | | Information | NG-RAN node₁ | | |
| | | | 9.2.3.31 | | | |
| Global NG-RAN Node ID | O | | 9.2.2.3 | | YES | reject |
| AMF Region Information To | O | | AMF Region | List of all | YES | reject |
| Add | | | Information | added AMF | | |
| | | | 9.2.3.83 | Regions to | | |
| | | | | which the NG- | | |
| | | | | RAN node | | |
| | | | | belongs. | | |
| AMF Region Information To | O | | AMF Region | List of all | YES | reject |
| Delete | | | Information | deleted AMF | | |
| | | | 9.2.3.83 | Regions to | | |
| | | | | which the NG- | | |
| | | | | RAN node | | |
| | | | | belongs. | | |
| Interface Instance Indication | O | | 9.2.2.39 | | YES | reject |
| TNL Configuration Info | O | | 9.2.3.96 | | YES | ignore |

| Range bound | Explanation |
|---|---|
| maxnoofTNLAssociations | Maximum numbers of TNL Associations between the NG RAN |
| | nodes. Value is 32. |

Served Cells To Update NR. This IE contains updated configuration information for served NR cells exchanged between NG-RAN nodes.

| | | | IE type and | Semantics | | Assigned |
|---|---|---|---|---|---|---|
| IE/Group Name | Presence | Range | reference | description | Criticality | Criticality |
| Served Cells NR To Add | | 0 . . . | | List of added cells | GLOBAL | reject |
| | | <maxnoofCellsinNG- | | served by the NG- | | |
| | | RAN node> | | RAN node. | | |
| >Served Cell Information | M | | 9.2.2.11 | | — | |
| NR | | | | | | |
| >Neighbour Information | O | | 9.2.2.13 | | — | |
| NR | | | | | | |
| >Neighbour Information | O | | 9.2.2.14 | | — | |
| E-UTRA | | | | | | |
| Served Cells To Modify | | 0 . . . | | List of modified cells | YES | reject |
| NR | | <maxnoofCellsinNG- | | served by the NG- | | |
| | | RAN node> | | RAN node. | | |
| >Old NR CGI | M | | NR CGI | | — | |
| | | | 9.2.2.7 | | | |
| >Served Cell Information | M | | 9.2.2.11 | | — | |
| NR | | | | | | |
| >Neighbour Information | O | | 9.2.2.13 | | — | |
| NR | | | | | | |
| >Neighbour Information | O | | 9.2.2.14 | | — | |
| E-UTRA | | | | | | |
| >Deactivation Impact/ | O | | 9.2.2.X | Indicates that the | — | |
| Monitoring Indication | | | | concerned cell is | | |
| | | | | switched off for | | |
| | | | | energy saving | | |
| | | | | reasons. Optionally | | |
| | | | | requests to monitor | | |
| | | | | the impact for UEs | | |
| | | | | served by the other | | |
| | | | | NG-RAN node and | | |
| | | | | report certain UE | | |
| | | | | performance | | |
| | | | | feedback. | | |
| Served Cells To Delete | | 0 . . . | | List of deleted cells | YES | reject |
| NR | | <maxnooffCellsinNG- | | served by the NG- | | |
| | | RAN node> | | RAN node. | | |
| >Old NR-CGI | M | | NR CGI | | — | |
| | | | 9.2.2.7 | | | |

| Range bound | Explanation |
|---|---|
| maxnoofCellsinNG- | Maximum no. cells that can be served by a NG-RAN node. Value is |
| RAN node | 16384. |

### Deactivation Impact Monitoring Indication

The Deactivation Impact Monitoring Indication IE indicates that the concerned cell is switched off for energy saving reasons and optionally that the impact for WCDs served by the other NG-RAN node should be monitored and reported in form of WCD performance feedback.

| | | | | |
|---|---|---|---|---|
| | | | IE type and | |
| IE/Group Name | Presence | Range | reference | Semantics description |

| | | | |
|---|---|---|---|
| Deactivation Indication | M | ENUMERATED | Indicates that the concerned |
| | | (deactivated, . . .) | cell is switched off for energy |
| | | | saving reasons. |
| Impact Monitoring Indication | O | | |
| > Impact Monitoring Request | M | ENUMERATED | Indicates to monitor the cell |
| | | (true, false, . . .) | deactivation impact and report |
| | | | UE performance feedback. |
| | | | “True” corresponds to start. |
| | | | “False” corresponds to stop. |
| > In-Coverage Probability | O | INTEGER | Indicates to monitor the cell |
| | | (0 . . . 100 . . .) | deactivation impact for UEs |
| | | | that are in coverage of the cell |
| | | | with indicated probability in |
| | | | percentage. Value 100 |
| | | | indicates to use reference- |
| | | | signal-based methods only. |

### Cell Activation Request

This message is sent by the NG-RAN node 1 to the peer NG-RAN node 2 to request a previously switched-off cell/s to be re-activated.

Direction: NG-RAN node 1→NG-RAN node 2.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE Served Cells To | M | | | | YES | reject |
| Activate | | | | | | |
| >NR Cells | | | | | | |
| >>NR Cells List | | 1 | | | — | |
| >>>NR Cells item | | 1 . . . | | | — | |
| | | <maxnoofCellsinNG- | | | | |
| | | RANnode> | | | | |
| >>>>NR CGI | M | | 9.2.2.7 | | — | |
| >>>>Cell Impact | O | | | | — | |
| >>>>>Cell ID | M | | Global NG- | Cell that | — | |
| | | | RAN Cell | currently | | |
| | | | Identity | serves the | | |
| | | | 9.2.2.27 | UEs which | | |
| | | | | would be in | | |
| | | | | coverage of | | |
| | | | | the cell to be | | |
| | | | | activated. | | |
| >>>>>Radio | O | | 9.2.2.50 | Radio | — | |
| Resource Status | | | | resources | | |
| | | | | consumed | | |
| | | | | by UEs that | | |
| | | | | would be in | | |
| | | | | coverage of | | |
| | | | | the cell to be | | |
| | | | | activated. | | |
| >>>>>Composite | O | | 9.2.2.51 | Composite | — | |
| Available Capacity | | | | available | | |
| Group | | | | capacity | | |
| | | | | consumed | | |
| | | | | by UEs that | | |
| | | | | would be in | | |
| | | | | coverage of | | |
| | | | | the cell to be | | |
| | | | | activated. | | |
| >>>>>Slice | O | | 9.2.2.55 | Slice | — | |
| Available Capacity | | | | Available | | |
| | | | | Capacity | | |
| | | | | consumed | | |
| | | | | by UEs that | | |
| | | | | would be in | | |
| | | | | coverage of | | |
| | | | | the cell to be | | |
| | | | | activated. | | |
| >>>>>Number of | O | | 9.2.2.62 | Number of | — | |
| Active UEs | | | | Active UEs | | |
| | | | | that would | | |
| | | | | be in | | |
| | | | | coverage of | | |
| | | | | the cell to be | | |
| | | | | activated. | | |
| >>>>UE Performance | O | | | | — | |
| >>>>>Bitrate | O | | | Bitrate | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>Latency | O | | | Latency | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>Packet Loss | O | | | Packet Loss | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>UE Energy | O | | | UE Energy | — | |
| Performance | | | | Performance | | |
| Statistics | | | | statistics for | | |
| | | | | the UEs that | | |
| | | | | would be in | | |
| | | | | coverage of | | |
| | | | | the cell to be | | |
| | | | | activated. | | |
| >E-UTRA Cells | | | | | | |
| >>E-UTRA Cells List | | 1 | | | — | |
| >>>E-UTRA Cells | | 1 . . . | | | — | |
| item | | <maxnoofCellsinNG- | | | | |
| | | RANnode> | | | | |
| >>>>E-UTRA CGI | M | | 9.2.2.8 | | — | |
| >>>>Cell Impact | O | | | | — | |
| >>>>>Cell ID | M | | Global NG- | Cell that | — | |
| | | | RAN Cell | currently | | |
| | | | Identity | serves the | | |
| | | | 9.2.2.27 | UEs which | | |
| | | | | would be in | | |
| | | | | coverage of | | |
| | | | | the cell to be | | |
| | | | | activated. | | |
| >>>>>Radio | O | | 9.2.2.50 | Radio | — | |
| Resource Status | | | | resources | | |
| | | | | consumed | | |
| | | | | by UEs that | | |
| | | | | would be in | | |
| | | | | coverage of | | |
| | | | | the cell to be | | |
| | | | | activated. | | |
| >>>>>Composite | O | | 9.2.2.51 | Composite | — | |
| Available Capacity | | | | available | | |
| Group | | | | capacity | | |
| | | | | consumed | | |
| | | | | by UEs that | | |
| | | | | would be in | | |
| | | | | coverage of | | |
| | | | | the cell to be | | |
| | | | | activated. | | |
| >>>>>Slice | O | | 9.2.2.55 | Slice | — | |
| Available Capacity | | | | Available | | |
| | | | | Capacity | | |
| | | | | consumed | | |
| | | | | by UEs that | | |
| | | | | would be in | | |
| | | | | coverage of | | |
| | | | | the cell to be | | |
| | | | | activated. | | |
| >>>>>Number of | O | | 9.2.2.62 | Number of | — | |
| Active UEs | | | | Active UEs | | |
| | | | | that would | | |
| | | | | be in | | |
| | | | | coverage of | | |
| | | | | the cell to be | | |
| | | | | activated. | | |
| >>>>UE Performance | O | | | | — | |
| >>>>>Bitrate | O | | | Bitrate | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>Latency | O | | | Latency | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>Packet Loss | O | | | Packet Loss | — | |
| Statistics | | | | statistics for | | |
| | | | | the UEs that | | |
| | | | | would be in | | |
| | | | | coverage of | | |
| | | | | the cell to be | | |
| | | | | activated. | | |
| >>>>>UE Energy | O | | | UE Energy | — | |
| Performance | | | | Performance | | |
| Statistics | | | | statistics for | | |
| | | | | the UEs that | | |
| | | | | would be in | | |
| | | | | coverage of | | |
| | | | | the cell to be | | |
| | | | | activated. | | |
| Activation ID | M | | INTEGER | Allocated by | YES | reject |
| | | | (0 . . . 255) | the NG-RAN | | |
| | | | | node₁ | | |
| Interface Instance | O | | 9.2.2.39 | | YES | reject |
| Indication | | | | | | |

| Range bound | Explanation |
|---|---|
| maxnoofCellsinNG- | Maximum no. cells that can be served by an NG-RAN node. |
| RANnode | Value is 16384. |

### Cell Activation Response

This message is sent by an NG-RAN node 2 to a peer NG-RAN node 1 to indicate that one or more cell(s) previously switched-off has (have) been activated.

Direction: NG-RAN node 2→NG-RAN node 1.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE Activated Served | M | | | | YES | reject |
| Cells | | | | | | |
| >NR Cells | | | | | | |
| >>NR Cells List | | 1 | | | — | |
| >>>NR Cells Item | | 1 . . . | | | — | |
| | | <maxnoffCellsinNG- | | | | |
| | | RANnode> | | | | |
| >>>>NR CGI | M | | 9.2.2.7 | | — | |
| >E-UTRA Cells | | | | | | |
| >>E-UTRA Cells List | | 1 | | | — | |
| >>>E-UTRA Cells | | 1 . . . | | | — | |
| Item | | <maxnoofCellsinNG- | | | | |
| | | RANnode> | | | | |
| >>>>E-UTRA CGI | M | | 9.2.2.8 | | — | |
| CHOICE Served Cells Not | M | | | | YES | reject |
| Activated | | | | | | |
| >NR Cells | | | | | | |
| >>NR Cells List | | 1 | | | — | |
| >>>NR Cells Item | | 1 . . . | | | — | |
| | | <maxnoffCellsinNG- | | | | |
| | | RANnode> | | | | |
| >>>>NR CGI | M | | 9.2.2.7 | | — | |
| >>>>Predicted NW | | | INTEGER | Predicted | — | |
| Energy Performance | | | (−100 . . . 0, . . .) | NW Energy | | |
| Gain | | | | Performance | | |
| | | | | Gain if the | | |
| | | | | indicated cell | | |
| | | | | activation | | |
| | | | | takes place. | | |
| >E-UTRA Cells | | | | | | |
| >>E-UTRA Cells List | | 1 | | | — | |
| >>>E-UTRA Cells | | 1 . . . | | | — | |
| Item | | <maxnoofCellsinNG- | | | | |
| | | RANnode> | | | | |
| >>>>E-UTRA CGI | M | | 9.2.2.8 | | — | |
| >>>>Predicted NW | | | INTEGER | Predicted | — | |
| | | | (−100 . . . 0, . . .) | NW Energy | | |
| | | | | Performance | | |
| | | | | Gain if the | | |
| | | | | indicated cell | | |
| Energy Performance | | | | activation | | |
| Gain | | | | takes place. | | |
| Activation ID | M | | INTEGER | Allocated by | YES | reject |
| | | | (0 . . . 255) | the NG-RAN | | |
| | | | | node₁ | | |
| Criticality Diagnostics | O | | 9.2.3.3 | | YES | ignore |
| Interface Instance | O | | 9.2.2.39 | | YES | reject |
| Indication | | | | | | |

| Range bound | Explanation |
|---|---|
| maxnoofCellsinNG- | Maximum no. cells that can be served by an NG-RAN node. Value |
| RANnode | is 16384. |

### Cell Activation Failure

This message is sent by an NG-RAN node 2 to a peer NG-RAN node 1 to indicate cell activation failure.

Direction: NG-RAN node 2→NG-RAN node 1.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Activation ID | M | | INTEGER | Allocated by | YES | reject |
| | | | (0 . . . 255) | the NG-RAN | | |
| | | | | node₁ | | |
| Cause | M | | 9.2.3.2 | | YES | ignore |
| Criticality Diagnostics | O | | 9.2.3.3 | | YES | ignore |
| Interface Instance | O | | 9.2.2.39 | | YES | reject |
| Indication | | | | | | |
| Served Cells Not Activated | O | | | | YES | reject |
| >NR Cells | | | | | | |
| >>NR Cells List | | 1 | | | — | |
| >>>NR Cells Item | | 1 . . . | | | — | |
| | | <maxnoffCellsinNG- | | | | |
| | | RANnode> | | | | |
| >>>>NR CGI | M | | 9.2.2.7 | | — | |
| >>>>Predicted NW | M | | INTEGER | Predicted | — | |
| Energy Performance | | | (−100 . . . 0, . . .) | NW Energy | | |
| Gain | | | | Performance | | |
| | | | | Gain if the | | |
| | | | | indicated cell | | |
| | | | | activation | | |
| | | | | takes place. | | |
| >E-UTRA Cells | | | | | | |
| >>E-UTRA Cells List | | 1 | | | — | |
| >>>E-UTRA Cells | | 1 . . . | | | — | |
| Item | | <maxnoofCellsinNG- | | | | |
| | | RANnode> | | | | |
| >>>>E-UTRA CGI | M | | 9.2.2.8 | | — | |
| >>>>Predicted NW | M | | INTEGER | Predicted | — | |
| Energy Performance | | | (−100 . . . 0, . . .) | NW Energy | | |
| Gain | | | | Performance | | |
| | | | | Gain if the | | |
| | | | | indicated cell | | |
| | | | | activation | | |
| | | | | takes place. | | |

The purpose of the Cause IE is to indicate the reason for a particular event for the XnAP protocol.

| | | | | |
|---|---|---|---|---|
| | | | | Semantics |
| IE/Group Name | Presence | Range | IE Type and Reference | Description |

| | | |
|---|---|---|
| CHOICE Cause | M | |
| Group | | |
| >Radio | | |
| Network Layer | | |
| >>Radio | M | ENUMERATED |
| Network | | (Cell not Available, |
| Layer Cause | | Handover Desirable for Radio Reasons, |
| | | Handover Target not Allowed, |
| | | Invalid AMF Set ID, |
| | | No Radio Resources Available in Target Cell, |
| | | Partial Handover, |
| | | Reduce Load in Serving Cell, |
| | | Resource Optimisation Handover, |
| | | Time Critical Handover, |
| | | TXn_{RELOCoverall} Expiry, |
| | | TXn_{RELOCprep} Expiry, |
| | | Unknown GUAMI ID, |
| | | Unknown Local NG-RAN node UE XnAP ID, |
| | | Inconsistent Remote NG-RAN node UE XnAP ID, |
| | | Encryption And/Or Integrity Protection Algorithms Not |
| | | Supported, |
| | | Protection Algorithms Not Supported, |
| | | Multiple PDU Session ID Instances, |
| | | Unknown PDU Session ID, |
| | | Unknown QoS Flow ID, |
| | | Multiple QoS Flow ID Instances, |
| | | Switch Off Ongoing, |
| | | Not supported 5QI value, |
| | | TXn_{DCoverall} Expiry, |
| | | TXn_{DCprep} Expiry, |
| | | Action Desirable for Radio Reasons, |
| | | Reduce Load, |
| | | Resource Optimisation, |
| | | Time Critical action, |
| | | Target not Allowed, |
| | | No Radio Resources Available, |
| | | Invalid QoS combination, |
| | | Encryption Algorithms Not Supported, |
| | | Procedure cancelled, |
| | | RRM purpose, |
| | | Improve User Bit Rate, |
| | | User Inactivity, |
| | | Radio Connection With UE Lost, |
| | | Failure in the Radio Interface Procedure, |
| | | Bearer Option not Supported, |
| | | UP integrity protection not possible, UP confidentiality |
| | | protection not possible, |
| | | Resources not available for the slice(s), |
| | | UE Maximum integrity protected data rate reason, |
| | | CP Integrity Protection Failure, |
| | | UP Integrity Protection Failure, |
| | | Slice(s) not supported by NG-RAN, |
| | | MN Mobility, |
| | | SN Mobility, |
| | | Count reaches max value, |
| | | Unknown Old NG-RAN node UE XnAP ID, |
| | | PDCP Overload, |
| | | DRB ID not available, |
| | | Unspecified, . . . , |
| | | UE Context ID not known, Non-relocation of context, |
| | | CHO-CPC resources to be changed, |
| | | RSN not available for the UP, |
| | | NPN access denied, |
| | | Report Characteristics Empty, |
| | | Existing Measurement ID, |
| | | Measurement Temporarily not Available, |
| | | Measurement not Supported For The Object, |
| | | UE Power Saving, |
| | | Not existing NG-RAN node₂ Measurement ID, |
| | | Insufficient UE Capabilities, Normal Release, |
| | | Action Desirable for NW Energy Efficiency Reasons), |
| >Transport | | |
| Layer | | |
| >>Transport | M | ENUMERATED |
| Layer Cause | | (Transport Resource Unavailable, |
| | | Unspecified, . . .) |
| >Protocol | | |
| >>Protocol | M | ENUMERATED |
| Cause | | (Transfer Syntax Error, |
| | | Abstract Syntax Error (Reject), |
| | | Abstract Syntax Error (Ignore and Notify), |
| | | Message not Compatible with Receiver State, |
| | | Semantic Error, |
| | | Abstract Syntax Error (Falsely Constructed Message), |
| | | Unspecified, . . .) |
| >Misc | | |
| >>Miscellaneous | M | ENUMERATED |
| Cause | | (Control Processing Overload, |
| | | Hardware Failure, |
| | | O&M Intervention, |
| | | Not enough User Plane Processing Resources, |
| | | Unspecified, . . .) |

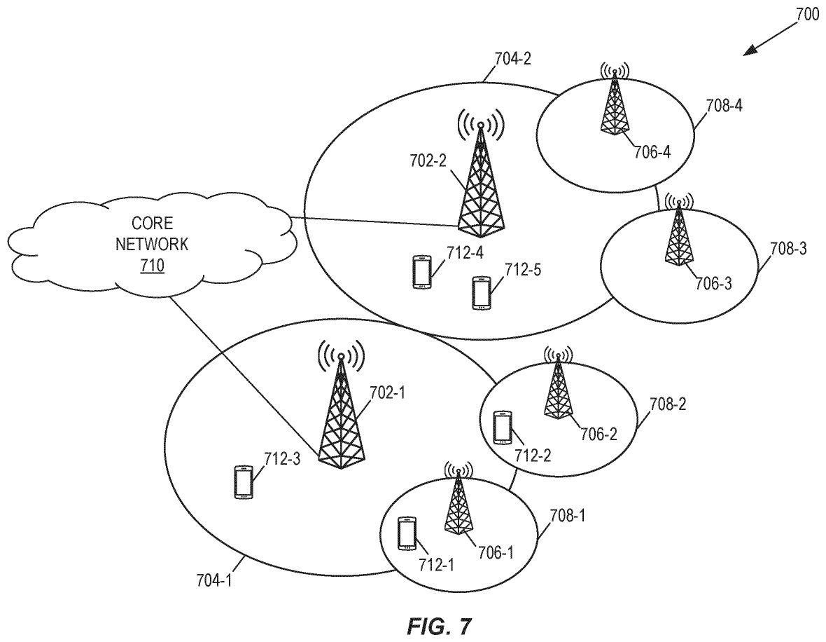

FIG. 7 illustrates one example of a wireless communications system 700 in which embodiments of the present disclosure may be implemented. In the embodiments described herein, the wireless communications system 700 can be a 5G System (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 702-1 and 702-2 (e.g., network nodes 102-1, and 102-2), which in the 5GS include NR base stations (gNBs) and optionally next generation eNBs (ng-eNBs) (e.g., LTE RAN nodes connected to the 5GC) and in the EPS include eNBs, controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. In an embodiment, the first network node 102-1 could be a low power node 706, while second network node 102-2 could be a base station 702. The wireless communications system 700 also includes a core network 710, which in the 5GS is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes WCDs, but the present disclosure is not limited thereto.

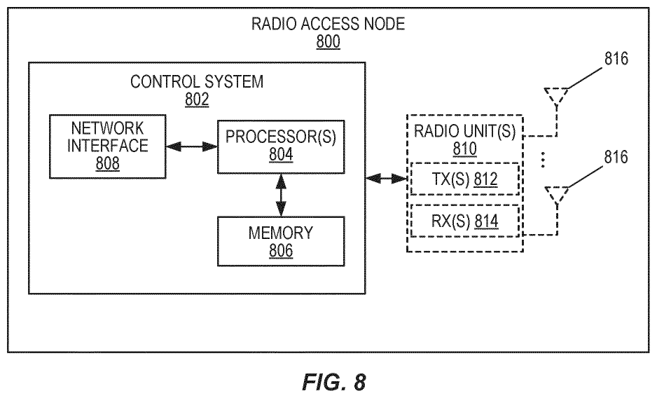

FIG. 8 is a schematic block diagram of a radio access node 800 according to some embodiments of the present disclosure. Optional features are represented by dashed boxes. The radio access node 800 may be, for example, first network node 102-1 or second network node 102-2 that implements all or part of the functionality of the base station 702 or gNB described herein. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

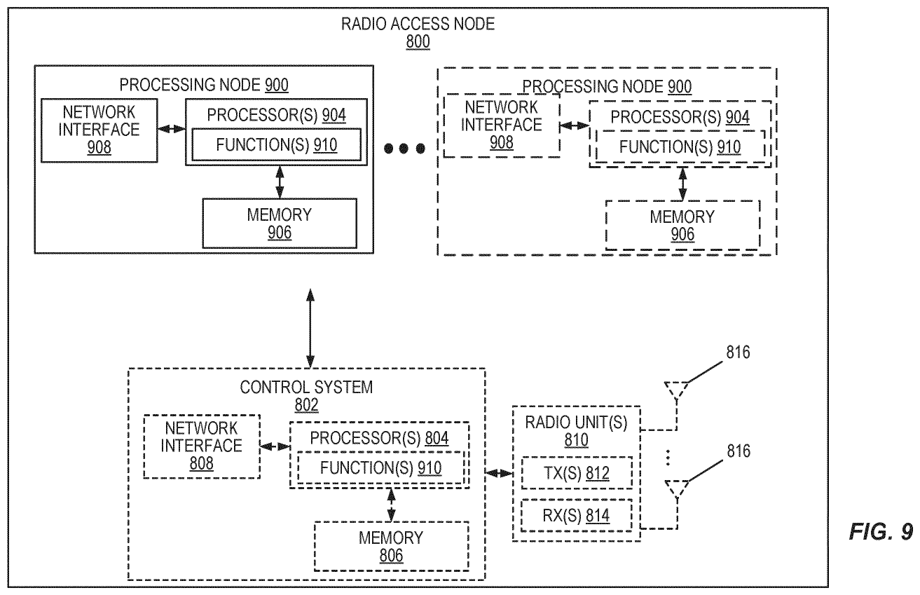

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 may include the control system 802 and/or the one or more radio units 810, as described above. The control system 802 may be connected to the radio unit(s) 810 via, for example, an optical cable or the like. The radio access node 800 includes one or more processing nodes 900 coupled to or included as part of a network(s) 902. If present, the control system 802 or the radio unit(s) are connected to the processing node(s) 900 via the network 902. Each processing node 900 includes one or more processors 904 (e.g., CPUs, ASICs, FPGAs, and/or the like), memory 906, and a network interface 908.

In this example, functions 910 of the radio access node 800 described herein are implemented at the one or more processing nodes 900 or distributed across the one or more processing nodes 900 and the control system 802 and/or the radio unit(s) 810 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

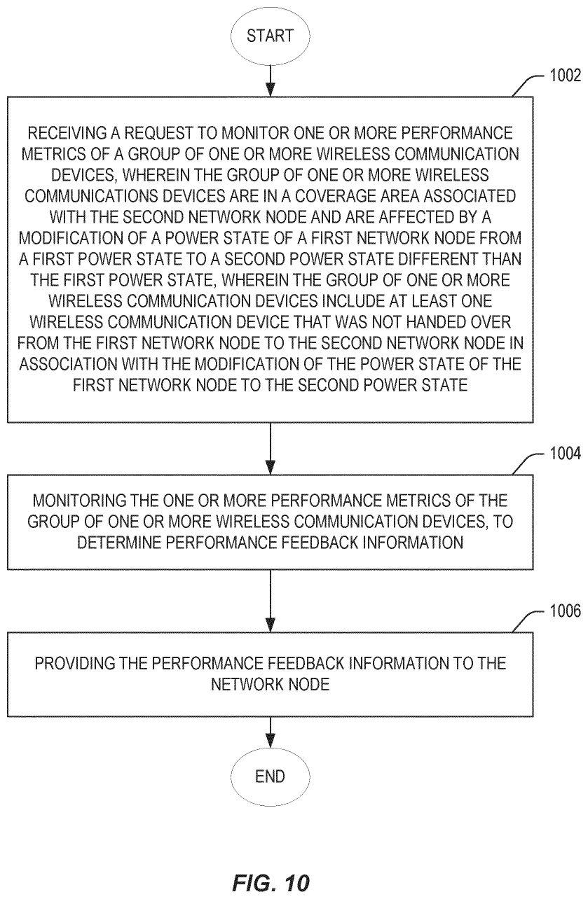

FIG. 10 is a flowchart of a method to provide feedback to a network node of a wireless network according to one or more embodiments of the present disclosure.

At 1002, the method includes receiving a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state.

At 1004, the method includes monitoring the one or more performance metrics of the group of one or more wireless communication devices, to determine performance feedback information.

At 1006, the method includes providing the performance feedback information to the network node.

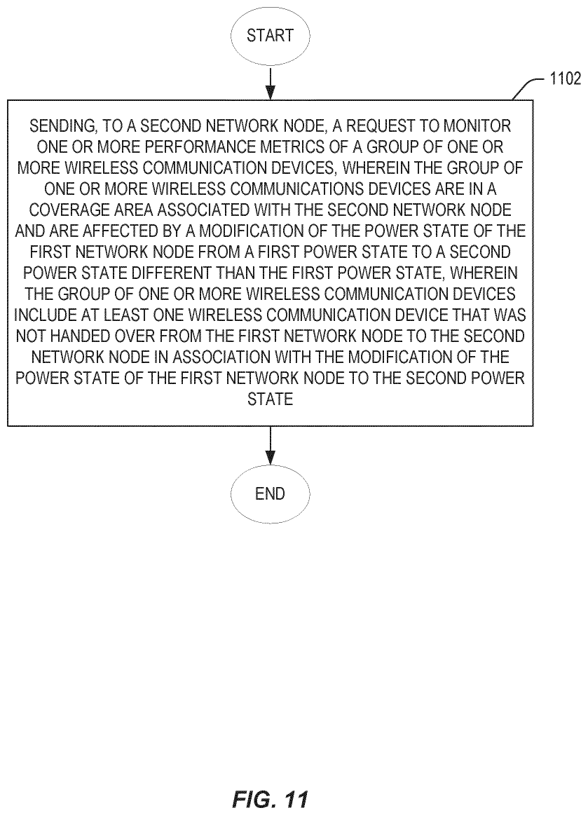

FIG. 11 is a flowchart of a method to configure performance monitoring and feedback reporting to a second network node of a wireless network according to one or more embodiments of the present disclosure.

At 1102, the method includes sending, to a second network node, a request to monitor one or more performance metrics of a group of one or more wireless communication devices, wherein the group of one or more wireless communications devices are in a coverage area associated with the second network node and are affected by a modification of the power state of the first network node from a first power state to a second power state different than the first power state, wherein the group of one or more wireless communication devices include at least one wireless communication device that was not handed over from the first network node to the second network node in association with the modification of the power state of the first network node to the second power state.

In some embodiments, a computer program including instructions which, when executed by at least one processor, causes the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some Example Embodiments of the present disclosure are as follows:

Embodiment 1: A method performed by a second network node (102-2) to provide feedback information to a network node of a wireless network, comprising:
receiving (208) a request to monitor one or more performance metrics of a group of one or more wireless communication devices (104), wherein the group of one or more wireless communications devices (104) are in a coverage area (106-2) associated with the second network node (102-2) and are affected by a modification of a power state of a first network node (102-1) from a first power state to a second power state lower than the first power state, wherein the group of one or more wireless communication devices (104) include at least one wireless communication device that was not handed over from the first network node (102-1) to the second network node (102-2) in association with the modification of the power state of the first network node (102-1) to the second power state; and
responsive to receiving the request:
   monitoring (210) the one or more performance metrics of the group of one or more wireless communication devices (104), to determine performance feedback information; and
   providing (212) the performance feedback information to the network node.

Embodiment 2: The method of embodiment 1, wherein providing (212) the performance feedback information to a network node comprises providing the performance feedback information to the first network node (102-1).

Embodiment 3: The method of embodiment 1, wherein providing (212) the performance feedback information to a network node comprises providing the performance feedback information to a network node associated with an operations, administration, and maintenance function (502) for the wireless network.

Embodiment 4: The method of any of embodiments 1 to 3, further comprising:
determining (404) that the first network node (102-1) has returned to a third power state higher than the second power state; and
handing over (216), by the second network node (102-2), at least one wireless communication device of the group of one or more wireless communication devices (104) to the first network node (102-1).

Embodiment 5: The method of any of embodiments 1 to 4, wherein the receiving the request to monitor the one or more performance metrics comprises receiving the request from at least one of the first network node (102-1) or a network node associated with an operations, administration, and maintenance function (502).

Embodiment 6: The method of any of embodiments 1 to 5, further comprising:
receiving a handover request for handover of one or more wireless communication devices from the first network node (102-1) to the second network node (102-2) in association with the modification of the power state of the first network node (102-1) to the second power state, wherein the handover request is associated with the request to monitor.

Embodiment 7: The method of any of embodiments 1 through 6, further comprising:
determining (209) the group of one or more wireless communications devices that are affected by the modification of the power state of the first network node (102-1) to the second power state based on a probability of the wireless communications devices of the group of one or more wireless communication devices (104) being served by the first network node (102-1), if the first network node (102-1) were in a fourth power state, exceeding a predefined threshold.

Embodiment 8: The method of embodiment 7, further comprising:
determining (209) the probability based on a coverage map comprising radio measurements of the wireless communications devices of the group of one or more wireless communication devices (104).

Embodiment 9: The method of embodiment 7, further comprising:
determining (209) the probability based on a secondary carrier prediction based on source carrier information received from the wireless communications devices of the group of one or more wireless communication devices (104).

Embodiment 10: The method of any of embodiments 1-9, wherein the group of one or more wireless communication devices (104) comprises at least one wireless communication device (104-1) that is not in a first coverage area (106-1) of the first network node (102-1) but is in a second coverage area (106-2) of the second network node (102-2).

Embodiment 11: The method of any of embodiments 1-9, wherein the group of one or more wireless communication devices (104) comprises at least one wireless communication device (104-4) that was inactive at the time the first network node (102-1) was modified to the second power state and was within a first coverage area (106-1) of the first network node (102-1) when the first network node (102-1) was in the first power state, but is in a second coverage area (106-2) of the second network node (102-2) when the first network node (102-1) is in the second power state.

Embodiment 12: The method of any of embodiments 1-9, wherein the group of one or more wireless communication devices (104) comprises at least one wireless communication device (104-3) that was not handed over from the first network node (102-1) to the second network node (102-2) and is in a coverage area (106-1) of the first network node (102-1).

Embodiment 13: A method performed by a network node to configure a power state of a first network node (102-1) of a wireless network, comprising:
sending (208), to a second network node (102-2), a request to monitor one or more performance metrics of a group of one or more wireless communication devices (104), wherein the group of one or more wireless communications devices are in a coverage area associated with the second network node (102-2) and are affected by a modification of the power state of the first network node (102-1) from a first power state to a second power state lower than the first power state, wherein the group of one or more wireless communication devices (104) include at least one wireless communication device (104-3) that was not handed over from the first network node (102-1) to the second network node (102-2) in association with the modification of the power state of the first network node (102-1) to the second power state.

Embodiment 14: The method of claim 13, further comprising:
receiving (212), from the second network node (102-2), performance feedback information associated with the group of one or more wireless communication devices (104);
determining (608), based at least in part on the outcome of using performance feedback information, to modify (610) the power state of the first network node (102-1).

Embodiment 15: The method of embodiment 14, further comprising:
responsive to modifying the power state of the first network node (102-1), receiving (212, 508) additional performance feedback information associated with the group of one or more wireless communication devices (104); and
updating (510) the machine learning model based on the additional performance feedback information.

Embodiment 16: A network node, comprising:
a memory that stores computer-executable instructions; and
a processor that executes the computer-executable instruction to perform operations, comprising:
   receiving (208) a request to monitor one or more performance metrics of a group of one or more wireless communication devices (104), wherein the group of one or more wireless communications devices (104) are in a coverage area (106-2) associated with the second network node (102-2) and are affected by a modification of the power state of the first network node (102-1) from a first power state to a second power state lower than the first power state, wherein the group of one or more wireless communication devices (104) include at least one wireless communication device that was not handed over from the first network node (102-1) to the second network node (102-2) in association with the modification of the power state of the first network node (102-1) to the second power state; and
   responsive to receiving the request:
      monitoring (210) the one or more performance metrics of the group of one or more wireless communication devices (104), to determine performance feedback information; and
      providing (212) the performance feedback information to a network node.

Embodiment 17: A network node of embodiment 16, configured to perform the method of any one of embodiments 2 to 15.

Embodiment 18: A non-transitory computer-readable storage medium that includes executable instructions to cause a processor device of a network node to:
receive (208) a request to monitor one or more performance metrics of a group of one or more wireless communication devices (104), wherein the group of one or more wireless communications devices (104) are in a coverage area (106-2) associated with the second network node (102-2) and are affected by a modification of the power state of the first network node (102-1) from a first power state to a second power state lower than the first power state, wherein the group of one or more wireless communication devices (104) include at least one wireless communication device that was not handed over from the first network node (102-1) to the second network node (102-2) in association with the modification of the power state of the first network node (102-1) to the second power state; and
responsive to receiving the request:
   monitor (210) the one or more performance metrics of the group of one or more wireless communication devices (104), to determine performance feedback information; and
   provide (212) the performance feedback information to a network node.

Embodiment 19: A network node, configured to perform operations comprising:
receiving (208) a request to monitor one or more performance metrics of a group of one or more wireless communication devices (104), wherein the group of one or more wireless communications devices (104) are in a coverage area (106-2) associated with the second network node (102-2) and are affected by a modification of the power state of the first network node (102-1) from a first power state to a second power state lower than the first power state, wherein the group of one or more wireless communication devices (104) include at least one wireless communication device that was not handed over from the first network node (102-1) to the second network node (102-2) in association with the modification of the power state of the first network node (102-1) to the second power state; and
responsive to receiving the request:
   monitoring (210) the one or more performance metrics of the group of one or more wireless communication devices (104), to determine performance feedback information; and
   providing (212) the performance feedback information to a network node.

Embodiment 20: A network node of embodiment 19, configured to perform the method of any one of embodiments 2 to 15.

1. A method performed by a second network node to provide feedback information to a network node of a wireless network, comprising:
receiving a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state; and
responsive to receiving the request:
monitoring the one or more performance metrics of the group of one or more wireless communication devices, to determine performance feedback information; and
providing the performance feedback information to the network node.

2. The method of claim 1, wherein providing the performance feedback information to a network node comprises providing the performance feedback information to the first network node.

3. The method of claim 1, wherein providing the performance feedback information to a network node comprises providing the performance feedback information to a network node associated with an operations, administration, and maintenance function for the wireless network.

4. The method of claim 1, wherein the receiving the request to monitor the one or more performance metrics comprises receiving the request from at least one of the first network node or a network node associated with an operations, administration, and maintenance function.

5. The method of claim 1, further comprising:
receiving a handover request for handover of one or more wireless communication devices from the first network node to the second network node in association with the modification of the power state of the first network node to the second power state, wherein the handover request is associated with the request to monitor.

6. The method of claim 1, further comprising:
determining that at least a portion of the group of one or more wireless communications devices that are affected by the modification of the power state of the first network node to the second power state based on a probability of the wireless communications devices of the group of one or more wireless communication devices being served by the first network node, if the first network node were in a fourth power state, exceeding a predefined threshold.

7. The method of claim 6, further comprising:
determining the probability based on a coverage map comprising radio measurements of the wireless communications devices of the group of one or more wireless communication devices.

8. The method of claim 6, further comprising:
determining the probability based on a secondary carrier prediction based on source carrier information received from the wireless communications devices of the group of one or more wireless communication devices.

9. The method of claim 1, wherein the group of one or more wireless communication devices comprises at least one wireless communication device that is not in a first coverage area of the first network node but is in a second coverage area of the second network node.

10. The method of claim 1, wherein the group of one or more wireless communication devices comprises at least one wireless communication device that was idle or inactive at the time the first network node was modified to the second power state and was within a first coverage area of the first network node when the first network node was in the first power state, but is in a second coverage area of the second network node when the first network node is in the second power state.

11.-16. (canceled)

17. A second network node, configured to perform operations comprising:
receiving a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state; and
responsive to receiving the request:
monitoring the one or more performance metrics of the group of one or more wireless communication devices, to determine performance feedback information; and
providing the performance feedback information to a network node.

18. (canceled)

19. A method performed by a network node to configure performance monitoring and feedback reporting to a second network node of a wireless network, comprising:
sending, to a second network node, a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state.

20. The method of claim 19, further comprising:
receiving, from the second network node, performance feedback information associated with the group of one or more wireless communication devices;
determining, based at least in part on the outcome of using performance feedback information, to modify the power state of the first network node.

21. The method of claim 20, further comprising:
responsive to modifying the power state of the first network node, receiving additional performance feedback information associated with the group of one or more wireless communication devices.

22. The method of claim 21, further comprising:
updating a machine learning model based at least in part on either the performance feedback information or the additional performance feedback information.

23.-26. (canceled)

27. A network node, configured to perform operations comprising:
sending, to a second network node, a request to monitor one or more performance metrics of a group of one or more wireless communication devices, wherein the group of one or more wireless communications devices are in a coverage area associated with the second network node and are affected by a modification of a power state of a first network node from a first power state to a second power state different than the first power state, wherein the group of one or more wireless communication devices include at least one wireless communication device that was not handed over from the first network node to the second network node in association with the modification of the power state of the first network node to the second power state.

28. (canceled)
